(19) United States
(12) Patent Application Publication
(10) Pub. No.: US 2006/0277843 A1
(43) Pub. Date: Dec. 14, 2006

(54) Structural tower

(76) Inventors: Tracy Livingston, Heber City, UT (US); Todd Andersen, Heber City, UT (US)

Correspondence Address: JAMES R. FARMER, Van Cott, Bagley, Cornwall & McCarthy, 50 S. Main St., Suite 1600, Salt Lake City, UT, 84108, US

(21) Appl. No.: 11/433,147

(22) Filed: May 12, 2006

Related U.S. Application Data
(60) Provisional application No. 60/681,235, filed on May 13, 2005.

(51) Int. Cl. H01Q 1/08

(52) U.S. Cl. 52/110

(57) ABSTRACT

A structural tower having a space frame construction for high elevation and heavy load applications is disclosed, with particular application directed to wind turbines. The structural tower includes damping or non-damping struts in the longitudinal, diagonal or horizontal members of the space frame. One or more damping struts in the structural tower damp resonant vibrations or vibrations generated by non-periodic wind gusts or sustained high wind speeds. The various longitudinal and diagonal members of the structural tower may be secured by pins, bolts, flanges or welds at corresponding longitudinal or diagonal joints of the space frame.

### RELATED APPLICATIONS

This present application claims priority to U.S. Provisional Patent Application No. 60/681,235, entitled “Structural Tower,” filed May 13, 2005.

### TECHNICAL FIELD OF THE INVENTION

The present invention relates to structural towers and devices for damping vibrations in structural towers, with specific application to structural towers for wind turbines.

### BACKGROUND OF THE INVENTION

Wind turbines are an increasingly popular source of energy in the United States and Europe and in many other countries around the globe. In order to realize scale efficiencies in capturing energy from the wind, developers are erecting wind turbine farms having increasing numbers of wind turbines with larger turbines positioned at greater heights. In large wind turbine farm projects, for example, developers typically utilize twenty-five or more wind turbines having turbines on the order of 1.2 MW positioned at fifty meters or higher. These numbers provide scale efficiencies that reduce the cost of energy while making the project profitable to the developer. Placing larger turbines at greater heights enables each turbine to operate substantially free of boundary layer effects created through wind shear and interaction with near-ground irregularities in surface contours—e.g., rocks and trees. Greater turbine heights also lead to more steady operating conditions at higher sustained wind velocities, thereby producing, on average, more energy per unit time. Accordingly, there are economic and engineering incentives to positioning larger turbines at greater heights.

Positioning larger turbines at greater heights comes, however, with a cost. The cost is associated with the larger and more massive towers that are required to withstand the additional weight of the larger turbines and withstand the wind loads generated by placing structures at the greater heights where wind velocities are also greater and more sustained. An additional cost concerns the equipment that is required to erect the wind turbine. For example, the weight of conventional tube towers for wind turbines—e.g., towers having sectioned tube-like configurations constructed using steel or concrete—increases in proportion to the tower height raised to the 5/3 power. Thus, a 1.5 MW tower typically weighing 176,000 lbs at a standard 65 meter height will weigh approximately 275,000 lbs at an 85 meter height, an increase of about 56 percent. Towers in excess of 250,000 lbs, or higher than 100 meters, however, generally require specialized and expensive cranes to assemble the tower sections and turbine. Just the cost to transport and assemble one of these cranes can exceed $250,000 for a typical 1.5 MW turbine. In order to amortize the expense associated with such large cranes, wind turbine farm developers desire to pack as many wind turbines as possible onto the project footprint, thereby spreading the crane costs over many wind turbines. However, with sites having limited footprints, developers are forced to amortize transport and assembly costs of the crane using fewer turbines, which may be economically unfeasible. Further, projects installed on rough ground require cranes to be repeatedly assembled and disassembled, which may also be economically unfeasible. Projects located on mountain top ridges or other logistically difficult sites may, likewise, be all but eliminated due to unfeasible economics, in addition to engineering difficulties associated with locating a crane at such sites.

There are other concerns associated with larger and more massive towers. For example, where turbine heights reach greater than approximately 90 meters, the tube diameters of conventional tube towers can exceed road height or weight restrictions. The wind turbine industry has investigated sectioning the tower pieces lengthwise, shipping, and then reassembling the pieces on site. The additional assembly costs, however, make this alternative unattractive. Even at 80 meters, where the tube diameters are smaller than those used for taller towers, all but the uppermost tower segments exceed the 80,000 lb capacity of most interstate roads. The freight costs associated with oversize trailers and special permitting of the tower sections can exceed many tens of thousands of dollars per wind turbine. Accordingly, the costs of transporting large steel tube towers can also serve to eliminate or hinder development of otherwise viable sites for wind turbines.

Conventional tube wind turbine towers can exceed 65 meters in height and have rotor diameters exceeding 70 meters (or blade rotor lengths on the order of 35 meters). The use of even larger rotor diameters with increasing turbine heights presents other challenges to the industry. Larger rotor diameters at greater heights are beneficial in that greater energy from lower wind speeds may be captured and transferred to the turbine per unit time. However, larger rotor diameters at greater heights tend to result in greater wind induced vibrations throughout the wind turbine structure and, in particular, the tower supporting the wind turbine. The wind induced vibrations—in particular, the resonant lateral and torsional vibrations experienced in the tower—can become excessive as the turbine height approaches or exceeds 80 to 100 meters with rotor diameters exceeding 70 meters.

To control the structural problems that can arise through resonant vibrations, wind turbine designers are often forced to de-rate the turbine to lower wind speeds, limit the maximum rotor diameter or reduce the tower height. Each of these options reduces, however, the overall economic efficiency of each wind turbine. Designers have also attempted to avoid the resonant vibrations by changing the stiffness of the tower—e.g., by increasing the tower stiffness through increasing the tower mass. Because the tower mass generally increases exponentially with the tower height, however, the cost of construction also increases exponentially, thus diminishing the economic advantages sought to be obtained through positioning turbine rotors of greater length at greater heights.

### SUMMARY OF THE INVENTION

The present invention circumvents many of the difficulties previously discussed and provides for a structural tower having a more-optimal balance between structural properties—e.g., bending and torsional stiffness and damping—and weight, thereby enabling development of economically viable wind turbine farms having increased power output per unit cost. The benefits of the present invention are several, and include a reduction in the cost of energy through a reduction in the cost of the tower, transportation, and assembly. The benefits further include more efficient generation of electricity through the use of larger turbines having greater rotor lengths positioned at ever greater elevations. These benefits reduce the cost of harnessing wind energy and enable more economical wind turbine farm installations in more locations than with conventional tube towers and thereby reduce dependence on non-renewable energy sources. Each of the benefits is, moreover, realized regardless of whether the wind turbine structures are constructed, individually or in large numbers, on land or offshore at sea. Further cost reductions through use of the space frame towers of the present invention arise through elimination of the transportation bottleneck associated with conventional tube towers. The ability to use much larger capacity turbines further enhances economies of scale.

The present invention includes a damped structural tower having a space frame construction in one or more sections or bays of the tower that includes a plurality of upwardly directed longitudinal members and a plurality of diagonal members interconnecting the longitudinal members, wherein at least one of the longitudinal and diagonal members or, alternatively, a horizontal member, is a damping member—e.g., a longitudinal, diagonal or horizontal member that includes a dashpot or similar means for damping vibrational energy. In one embodiment, the structural tower includes at least one damping member having a viscous fluid. In a further embodiment, the structural tower includes at least one damping member having a viscoelastic or rubber-like material. In both embodiments, shear stresses occurring in the viscous fluid or viscoelastic or rubber-like material affect damping of vibrational energy. See, e.g., Chopra, Anil K., “Dynamic of Structures,” Prentice-Hall (2001) for a discussion of the effect of damping on structures vibrating near resonant frequencies.

As will become apparent through the disclosure of the present invention, the damping members disclosed herein generally include a dashpot and a spring element constructed in integral fashion. The spring element (e.g., a steel, aluminum, or composite beam) provides stiffness to the damping member and the dashpot (e.g., a viscous or hydraulic damper) serves to damp vibrational energy. Several of the damping member embodiments disclosed herein include both the spring and dashpot elements as an integral unit and operating in parallel. It should be appreciated, however, that the dashpot and spring elements can be constructed in a non-integral fashion—e.g., they can be constructed and arranged in one or more bays of the tower and appear substantially side-by-side or substantially perpendicular to one another. More specifically, the latter embodiment contemplates positioning a dashpot—e.g., a fluid shock absorber—in proximity to a spring element (or non-damping member) such as a steel beam. Various embodiments of the foregoing are described below with reference to the appended drawings.

For example, in one embodiment of a damping member, a viscous fluid damping member includes a first diagonal member having first and second ends configured to interconnect a pair of longitudinal members, a second member disposed within the first having a first end connected to one end of the first member, and a viscous or hydraulic damper operably connected to a second end of the second member. In one embodiment, the viscous or hydraulic damper includes a cylinder, a piston slidably engaged within the cylinder, and a connecting member having a first end connected to the piston and a second end connected to the second end of the second member. For purposes of clarification, the term viscous fluid damping member or simply viscous damping member refers generally to a diagonal, longitudinal or horizontal member of a space frame structural tower comprising a fluid dashpot or, more specifically and by way of example, a viscous or hydraulic fluid damper or an air damper to affect damping of vibrational energy. The terms viscous damper and hydraulic damper are used interchangeably herein and refer generally to a dashpot device having a viscous fluid for dissipating vibrational energy. Similarly, an air damper refers to a dashpot device where air or a similar gas acts as the working fluid for dissipation of vibrational energy.

As another example, in one embodiment of a damping member, a viscoelastic damping member includes first and second tubular members with each member having a first end and a second end, and with the first tubular member being disposed inside the second tubular member. The first tubular member has a first pattern of reinforcing fibers disposed in a first matrix, and the second tubular member has a second pattern of reinforcing fibers disposed in a second matrix. A viscoelastic material is disposed between the first and second patterns of reinforcing fibers. In one embodiment, a first connector is disposed at the first ends of the first and second tubular members and a second connector is disposed at the second ends of the first and second tubular members, with the connectors being configured to interconnect a pair of the longitudinal members. For purposes of clarification, the term viscoelastic damping member refers generally to a diagonal, longitudinal or horizontal member of a space frame structural tower comprising a non-fluid dashpot or, more specifically and by way of example, a viscoelastic or rubber-like material to affect damping of vibrational energy.

As used herein, the term dashpot refers generally to a device that affects damping or dissipation of vibrational energy, and may include either or both fluid or non-fluid means for the dissipation of energy through, for example, shearing stresses set up in the fluid or non-fluid means—e.g., hydraulic or viscous fluid or material, respectively. Those skilled in the art will appreciate, of course, that a dashpot, in its most general sense, refers to any means of dissipating energy or affecting damping in a vibrational system. Accordingly, and as a yet another point of clarification, the term damping member refers generally to a diagonal, longitudinal or horizontal member of a space frame structural tower that includes a dashpot as that term is used in its most general sense.

In one embodiment of the tower, one or more damping members are disposed diagonally and interconnect adjacent longitudinal members. In a second embodiment, one or more damping members are disposed longitudinally and interconnect adjacent longitudinal members. In yet a third embodiment, one or more damping members are disposed horizontally, and interconnect adjacent longitudinal or diagonal members. In yet a further embodiment, one or more damping members or, alternatively, dashpot assemblies are operably connected to amplification members, which serve to amplify small displacements in various members of the tower into relatively large displacements of the damping members or dashpot assemblies. In other embodiments, various combinations of damping members substitute for one or more of the various longitudinal, diagonal or horizontal members that comprise a structural tower having one bay or a multiple-bay, space frame construction.

The present invention further includes a structural tower having a plurality of upwardly directed longitudinal members and a plurality of diagonal members interconnecting the longitudinal members, wherein the plurality of longitudinal members and the plurality of diagonal members are arranged and interconnected in an upwardly extending single or multiple-bay configuration secured using pins that connect longitudinal members to adjacent longitudinal members or adjacent diagonal members. The structural tower includes at least three upwardly directed longitudinal members spaced substantially equidistant about a longitudinal axis. In one embodiment, diagonal members interconnect each adjacent pair of the at least three upwardly directed longitudinal members. In a further embodiment, pin joints are used to interconnect the ends of each diagonal member to corresponding adjacent pairs of longitudinal members. In still further embodiments, each end of the diagonal members includes a flange member having an aperture sized and configured to tightly receive the pin, while the corresponding adjacent pairs of longitudinal members each include corresponding flange members having apertures sized and configured to tightly receive the pin.

The present invention further includes a method of assembling a structural tower having a space frame construction comprising the steps of providing first pluralities of longitudinal and diagonal members and a foundation for the structural tower, the foundation having a plurality of support members configured to receive an end of the longitudinal members. An end of each of the first plurality of longitudinal members is secured to a corresponding one of the plurality of support members, and the longitudinal members are themselves interconnected by the diagonal members, wherein the plurality of longitudinal members and the plurality of diagonal members are arranged and interconnected in an upwardly extending bay configuration.

In one embodiment, further steps of constructing the tower include providing second pluralities of longitudinal and diagonal members. The ends of the second plurality of longitudinal members are connected to corresponding ends of the first plurality of longitudinal members, and the second plurality of longitudinal members are interconnected by the second plurality of diagonal members, wherein the pluralities of first and second longitudinal members and the pluralities of first and second diagonal members are arranged and interconnected in an upwardly extending multiple-bay configuration.

Features from any of the above mentioned embodiments may be used in combination with one another in accordance with the present invention. In addition, other features and advantages of the present invention will become apparent to those of ordinary skill in the art through consideration of the ensuing description, the accompanying drawings, and the appended claims.

### BRIEF DESCRIPTION OF THE DRAWINGS

FIG. 1 illustrates a perspective view of a structural tower of the present invention having a wind turbine assembly mounted thereon;

FIG. 2 illustrates a perspective view of a bay section of the structural tower of the present invention shown in FIG. 1;

FIG. 3 illustrates a close-up view of a typical joint section of the bay section illustrated in FIG. 2;

FIG. 4 illustrates an exploded and partially cut away view of a lengthwise joint construction between two longitudinal members illustrated in FIG. 3;

FIG. 5 illustrates an exploded and partially cut away view of a lengthwise and diagonal joint construction between two longitudinal members and a diagonal member;

FIG. 6 illustrates a view of the exploded components of FIG. 5 in fully assembled form;

FIG. 7 illustrates a side view of the cylindrical bay section of the structural tower of the present invention shown in FIG. 1 with a wind turbine attached thereto;

FIG. 8 illustrates a perspective cutaway view of a connector assembly fastened to a composite strut;

FIG. 9 illustrates a composite strut of the present invention used as a longitudinal member;

FIG. 10 illustrates a composite strut of the present invention used as a horizontal member;

FIG. 11 illustrates a perspective cutaway view of a connector assembly fastened to a composite damping strut;

FIG. 12 illustrates a perspective cutaway view of a connector assembly fastened to an alternative composite damping strut;

FIG. 13 illustrates a cutaway view of an alternative to the composite damping strut of the present invention;

FIG. 14 illustrates a cutaway view of a second alternative to the composite damping strut of the present invention;

FIG. 15 illustrates a cutaway view of a viscous damping strut;

FIG. 16 illustrates a cutaway view of an alternative viscous damping strut.

FIG. 17 illustrates a cutaway view of an alternative viscous damping strut.

FIG. 18 illustrates a perspective view of an alternative bay assembly having both damping and non-damping diagonal members;

FIG. 19 illustrates a perspective view of an alternative bay assembly having both damping and non-damping diagonal members;

FIG. 20 illustrates a perspective view of an alternative bay assembly having both damping and non-damping diagonal members, and damping amplification members;

FIGS. 21A and B illustrate the principle of operation of the amplification members shown in FIG. 20;

FIG. 22 illustrates a perspective view of an alternative bay assembly having both damping and non-damping diagonal members, and damping amplification members;

FIG. 23 illustrates a conventional tube tower having damping struts of the present invention substituted for a steel tube bay section;

FIG. 24 illustrates a close up view of the damping struts shown in FIG. 23;

FIG. 25 illustrates an alternative bay assembly for use with the present invention; and

FIG. 26 illustrates an alternative pin connection for use with the present invention.

### DETAILED DESCRIPTION OF THE INVENTION

Generally, the present invention relates to a structural tower comprising a space frame that is suitable for heavy load and high elevation applications. In further detail, the present invention relates to a structural tower comprising a space frame and having damping members for damping resonant vibrations and other vibrations induced, for example, by normal wind turbine operation and in response to extreme wind loads. The present invention further relates to wind turbine applications, where the wind turbine is elevated to heights approaching eighty to one hundred meters or higher and where rotor diameters approach seventy meters or greater. Details of exemplary embodiments of the present invention are set forth below.

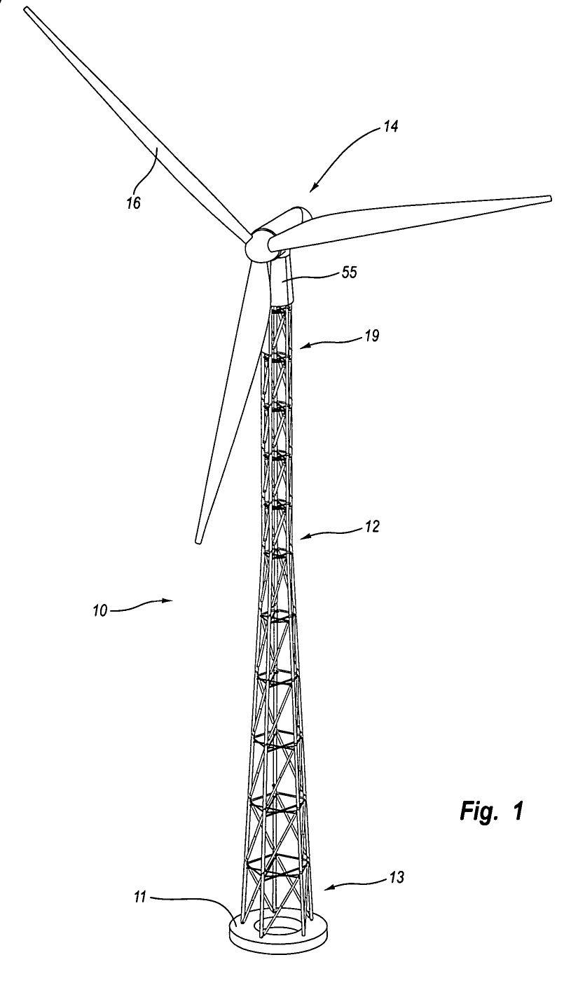

FIG. 1 illustrates a perspective view of one embodiment of a structural tower 10 of the present invention. The structural tower 10 comprises a plurality of space frame sections also commonly called bay assemblies or sections 12, 13, 19 that are assembled, one on top of the other, to the desired height of the structural tower 10. The lowermost bay assembly 13 of the structural tower 10 is secured to a foundation 11. The structural tower 10 has a horizontal-axis wind turbine 14 positioned atop the uppermost bay assembly 19, although a vertical-axis turbine could be equally well positioned atop the tower. One or more of the structural towers 10 may also be connected together to support the wind turbine or multiple wind turbines. A conventional tube-like bay section 55 connects the wind turbine 14 to the uppermost bay assembly 19, but the wind turbine 14 may also be connected to the uppermost bay assembly 19 using connections readily known to those skilled in the art or as described herein below. The wind turbine 14 carries a plurality of blades 16 that rotate in a typical fashion in response to wind. Rotation of the blades 16 drives a generator (not illustrated) that is integral to the wind turbine 14 and typically used to generate electricity. As those skilled in the art will appreciate, however, the wind turbine could be used for other things, such as, for example, driving a pump for pumping water or a driving a mill for grinding grain.

In one embodiment, the structural tower 10 of the present invention has a conventional wind turbine 14 of 1.5 MW capacity and blades 16 positioned thereon, with the tower extending eighty to one hundred meters or more in height above the foundation 11. Each individual bay section 12 is three to eight meters in length, although the length of each individual bay section 12 may vary along the length of the structural tower 10 and, in particular, toward the base of the structural tower 10 where the bay sections are typically of larger diameter than those positioned near the top of the tower. The diameter of each individual bay section 12 is from three to four meters along the mid and upper sections of the tower and will typically increase to about eight to twelve meters at the foundation 11. Larger or smaller bay section diameters are contemplated as the overall height of the tower increases or decreases, respectively, and will depend on the intended application and expected loading on the tower. An exemplar embodiment of a bay section 12 taken from the upper portion of the structural tower 10 is hereinafter described with particular emphasis given to wind turbine applications where the wind turbine is elevated to heights approaching one hundred meters or higher and where rotor diameters approach seventy meters or greater. The description of the exemplary bay section applies generally to each bay section of the structural tower, although those having skill in the art will recognize certain variations in construction and assembly that may be incorporated into any particular bay section of the tower.

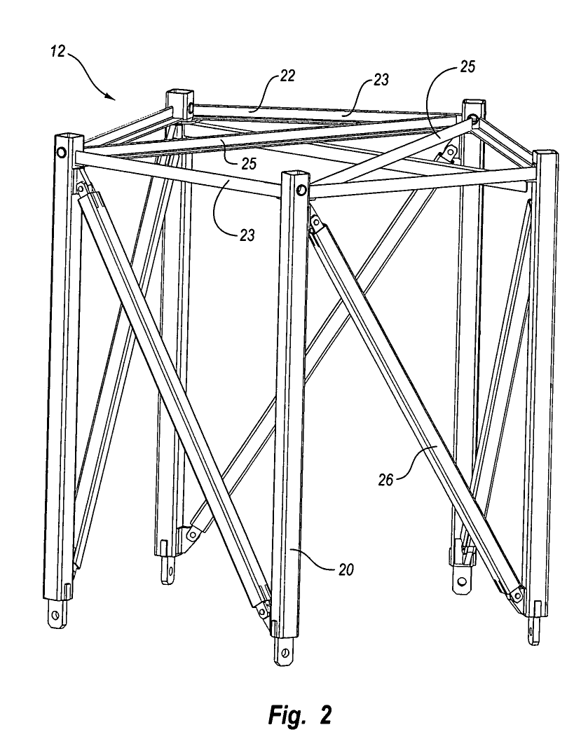

FIG. 2 illustrates a perspective view of a typical bay section 12 of the structural tower 10. In one embodiment, each of the bay sections 12 includes a plurality of longitudinal members 20 extending substantially vertically and arranged and spaced substantially equidistant on a circular perimeter centered about a central axis of the structural tower 10. The longitudinal members 20 are typically the length of the individual bay section 12, or about three to eight meters in length, depending on the position of the bay section along the length of the structural tower 10. In other embodiments, the individual longitudinal members may span the lengths of two or more bay sections, thereby reducing the number of longitudinal-to-longitudinal connections at adjacent bay sections. The longitudinal members 20 are typically constructed of high strength steel and are hollow and square in cross section, although round, angled, I-beam and C-channel cross sectional geometries or the like are also contemplated. Typical cross sectional dimensions of square cross sectioned longitudinal members 20 are ten by ten inches, with the wall thickness of each member being one-half to three-quarter inch thick, and in one embodiment about five-eights inch thick. Materials such as aluminum and composites provide suitable alternatives for constructing the longitudinal members 20. For example, in an alternative embodiment, the longitudinal members are constructed of composite materials that are circular in cross section with a cross sectional diameter on the order of ten inches and a wall thickness on the order of one to two inches thick.

Referring still to FIG. 2, the longitudinal members 20 are interconnected by a plurality of horizontal members 22 extending substantially horizontally between adjacent pairs of longitudinal members 20. In one embodiment, the horizontal members 22 interconnect pairs of successive longitudinal members 20 of the bay section 12 in both polygonal 23 and cross-bay 25 arrangements, although the polygonal 23 arrangement may be used without use of the cross-bay 25 arrangement and vice-versa. A rigid ring member (not illustrated), such as a steel ring, having a diameter substantially equal to the diametrical spacing of the longitudinal members provides a suitable alternative to, or may compliment, the use of horizontal members 22. In either case, the horizontal members 22, or the ring member, are connected to the longitudinal members 20 using bolts, pins (e.g., as discussed below) or by welding. In one embodiment, the horizontal members 22 are constructed using high strength steel, but materials such as aluminum and composites serve as suitable alternatives. For example, the horizontal members 22 may be constructed using stock high strength angled beams having side dimensions on the order of two to four inches in width and thicknesses on the order of three-eights to one-half inch. Alternatively, the horizontal members 22 may be constructed using steel, aluminum or composite materials of any suitable cross sectional shape, such as circular, square, I-beam or C-channel as would be understood by those skilled in the art.

Referring still to FIG. 2, diagonal members 26 extend diagonally between adjacent pairs of longitudinal members 20. The diagonal members 26 interconnect pairs of successive longitudinal members 20 about the perimeter of each bay section 12. The diagonal members 26 are typically about three to eight meters in length and oriented at an angle of approximately thirty to sixty degrees with respect to the adjacent longitudinal members 20. Ultimately, the length of each diagonal member 26 will depend on the length of the adjacent longitudinal members 20 that the diagonal member 26 connects, the spacing of adjacent longitudinal members and the angle of orientation that the diagonal member makes with respect to the longitudinal members 20. For example, the lengths of the diagonal members 26 included in the bay sections 12 located toward the base of the tower 10 will increase relative to the lengths of the diagonal members 26 included in the bays sections 12 located near the top of the structural tower 10. The diagonal members 26 are typically constructed of high strength steel and are hollow and square in cross section, although round, angle, I-beam and C-channel cross sectional geometries or the like are also contemplated. Typical cross sectional dimensions of square cross sectioned diagonal members 20 are ten by ten inches, with the wall thickness of each member being one-half to three-quarter inch thick, and in one embodiment about five-eights inch thick. Materials such as aluminum and composites provide suitable alternatives for constructing the diagonal members 26. For example, in an alternative embodiment, the diagonal members are constructed of composite materials that are circular in cross section with a cross sectional diameter on the order of ten inches and a wall thickness on the order of one to two inches thick.

The foregoing description with respect to FIG. 2 applies to a bay section 12 comprising the upper half of the structural tower illustrated in FIG. 1. The description is, however, generally applicable to the similar components that comprise the bay sections that comprise the lower half of the tower. The differences, if any, are generally limited to the geometry of the particular bay section. In one embodiment, for example, the bay sections comprising the lower end of the structural tower 10 include relatively longer horizontal members 22 to accommodate the relatively larger diameters of each bay section as the base of the tower adjacent the foundation 11 is approached. In similar fashion, the length of the diagonal members 26 will also increase to accommodate the relatively larger diameters of each bay section or, consistent therewith, the relatively larger spacing between adjacent pairs of longitudinal members 20. In addition, the longitudinal members 20 are, in one embodiment, positioned at a slight angle with respect to a central axis of the structural tower 10 so as to accommodate a gradual increase in the diameter of each bay section 12 as the foundation 11 is approached. Further, the longitudinal members 20 are secured to the foundation 11 using a series of plate or support members (not illustrated). The plate or support members are bolted or otherwise secured to the foundation 11. The lower ends of the longitudinal members connected to the foundation are secured to the plate or support members either by welding the lower ends directly to the plate or support members or by welding flange members (not illustrated) to the lower ends and then bolting the flange members to the plate or support members. Those skilled in the art will recognize other suitable ways to secure the lower ends to plate or support members, such as through use of a pin in conjunction with a lengthwise joint, the construction of which is discussed in detail below.

As one having skill in the art will appreciate, the exact number of individual bay sections and the precise dimensions of each bay section—or the variation, if any, in the dimensions of the various members that comprise each bay section along the length of the structural tower 10—may vary depending upon the intended application, the expected or anticipated loads due to wind or other sources, or the desire to shift one or more resonant frequencies by varying the stiffness of the tower. In one embodiment, however, each bay section along the length of the structural tower is identical to each of the other bay sections, meaning that all of the longitudinal members 20 are the same or nearly the same as each other, all of the diagonal members 26 are the same or nearly the same as each other, and all of the horizontal members 22 are the same or nearly the same as each other. Further, and as described above, one having skill in the art will appreciate that the various members that comprise each bay section—i.e., longitudinal, diagonal and horizontal members—may be omitted or included and constructed using steel, aluminum or composite materials, for example, or combinations thereof having various cross sectional geometries. For example, adding additional diagonal members may allow the removal of one or more of the horizontal and longitudinal members. The specific selection of component members, their material of construction and their cross sectional geometry may, however, depend on their positioning in the structural tower. For example, the stresses and loads experienced by the various members near the top of the tower can be expected to be less than those experienced by the various members near the bottom of the tower, thereby allowing members near the top of the tower to have, for example, smaller cross sectional geometries or wall thicknesses, or to be constructed from materials exhibiting comparatively reduced yield or ultimate strengths.

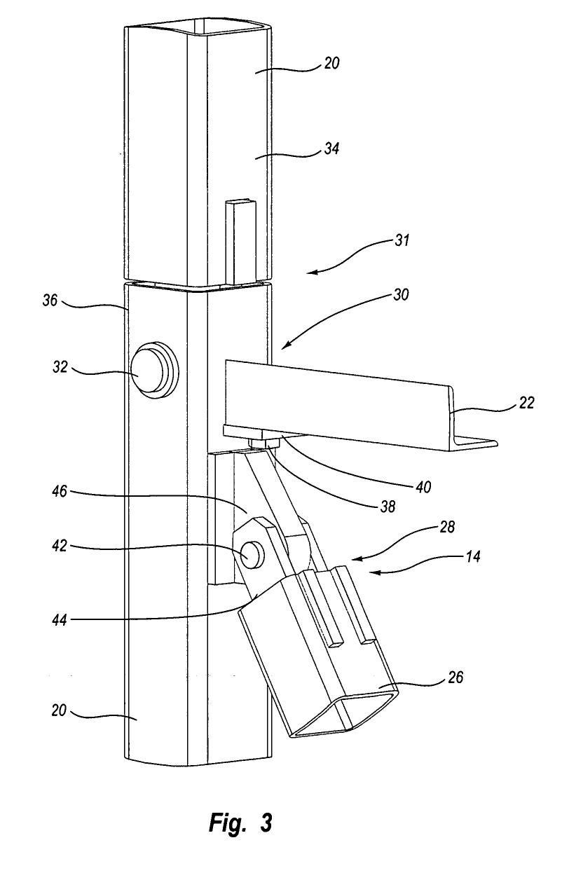

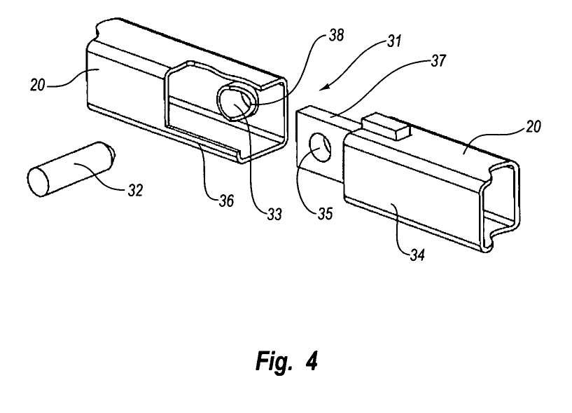

Having described certain features of the various component members that comprise one or more embodiments of the structural tower 10 of the present invention, the description proceeds herein with a description of a novel means of securing the component members to one another using pins. FIGS. 3 and 4 illustrate, for example, one embodiment of a joint section 30 showing the intersection of a set of longitudinal members 20, horizontal members 22 and diagonal members 26. The longitudinal members 20 are secured together at each lengthwise joint 31 by a pin 32 extending through corresponding male 34 and female 36 ends of the lengthwise joint 31. The pin 32 is in one embodiment four inches in diameter and constructed from steel. Referring to FIG. 4, the pin 32 extends through a pair of tube sections 33 (only one is illustrated in the figure) having closely matched diametrical tolerances with the pin 32. A tab member 37 of the male end 34 of the lengthwise joint 31 is sandwiched between the tube sections 33. Tube sections 33 are in one embodiment trimmed at the leading edge 38 to facilitate insertion of the tab member 37. The tab member 37 has an aperture 35 that is also dimensioned to closely match the diameter of the pin 32. When the lengthwise joint 31 is assembled, the pair of tube sections 33 prevent or minimize sideways movement of the tab member 37, while the close tolerances between the outside diameter of the pin 32 and the inside diameter of the tube sections 33 and aperture 35 maintain a tight fit at the lengthwise joint 31. In one embodiment, the diametric tolerance between the outside diameter of the pin 32 and the inside diameter of the tube sections 33 and aperture 35 may be no more than three one-hundredths (0.030) of an inch where a pin 32 having a four inch diameter is used.

Referring again to FIG. 3, each horizontal member 22 is secured to an adjacent longitudinal member 20 using bolts 38 extending through a tab member 40 that is welded to the longitudinal member 20. Alternatively, the horizontal members 22 may be welded directly to the longitudinal member 20 or pinned to the longitudinal members using any of the manners discussed above or below. The ends of each diagonal member 26 are secured to a corresponding longitudinal member 20 at a diagonal joint 41 using a pin 42 that extends through a pair of end flanges 44 that are formed as part of a pin-joint connector 28. The pin connection at the diagonal joint 41 is similar to the pin connection discussed above regarding the longitudinal joint 31. The pin 42 is in one embodiment four inches in diameter and constructed from steel. The pin 42 extends through the pair of end flanges 44 having apertures with diameters that closely match the diameter of the pin 42. Sandwiched between the end flanges 44 is a tab member 46 having an aperture (not illustrated) that is also dimensioned to closely match the diameter of the pin 42. When the diagonal joint 41 is assembled, the pair of end flanges 44 prevent the sideways motion of the connector 28, while the close tolerances between the outside diameter of the pin 42 and the inside diameter of the end flanges 44 and aperture through the tab member 46 maintain a tight fit at the diagonal joint 41. In one embodiment, the diametric tolerance between the outside diameter of the pin 42 and the inside diameter of the tab members 44 and aperture is no more than three one-hundredths (0.030) of an inch where a four inch diameter pin 42 is used. The tab member 46 is in one embodiment welded to the longitudinal member 20. Although a single tab member 46 and dual end flanges 44 may be used, it will be apparent that dual tab members and a single end flange on the connector 28 may also be used to secure a diagonal member 26 to a corresponding longitudinal member 20.

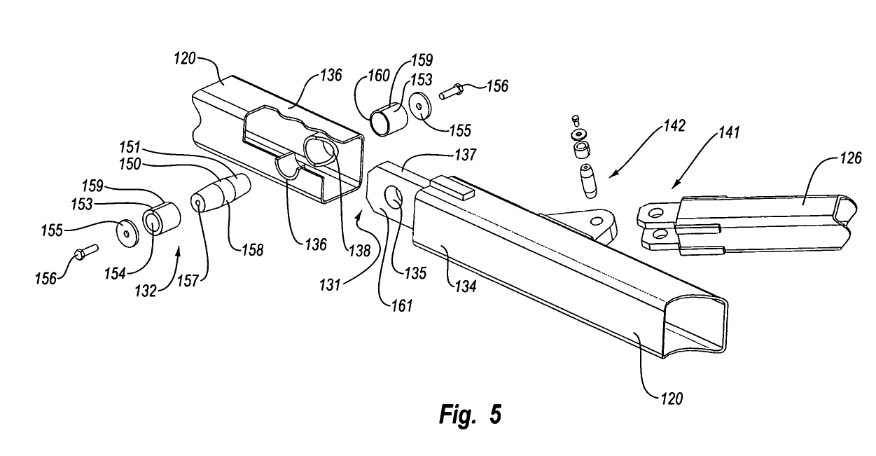

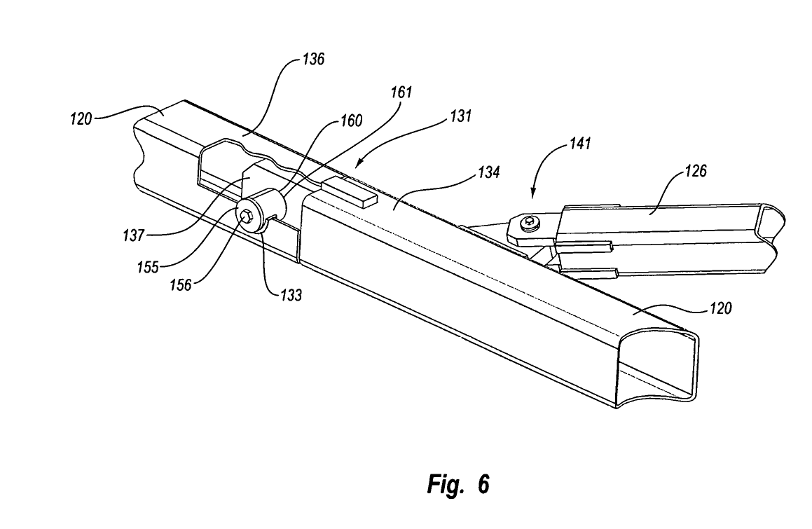

FIGS. 5 and 6 illustrate an alternative embodiment of a joint section 130 showing the intersection of a set of longitudinal members 120 and a diagonal member 126. The longitudinal members 120 are secured together at each lengthwise joint 131 by a pin assembly 132 extending through corresponding male 134 and female 136 ends of the lengthwise joint 131. The pin assembly 132 comprises in one embodiment a pin member 150 that includes tapered portions 151 on each of the ends of the pin member 150. The pin assembly 132 further includes a pair of collar members 153 having an inside surface 154 configured to tightly engage the tapered portion 151 of the pin member 150 when the collar member is fully fastened to the tapered portion 151 of the pin member 150. The pin assembly 132 further includes a pair of washer members 155 and a pair of bolts 156 that are configured to bolt into threaded holes 157 positioned at the ends of the pin member 150. The male end 134 of the lengthwise joint 131 includes a tab member 137 having an aperture 135 that is dimensioned to closely match the diameter of a non-tapered portion 158 located intermediate the tapered portions 151 of the pin member 150. The pin member 150 extends through a pair of tube sections 133 having closely matched diametrical tolerances with the collar members 153 when fully expanded. A lengthwise slot 159 is positioned along the length of each collar member 153 to permit diametric expansion of the collar member 153 when forced fully onto the tapered portion 151 of the pin member 150. Similar to that discussed above, the tube sections are in one embodiment trimmed at the leading edge 138 to facilitate insertion of the tab member 137.

In one embodiment, assembly of the tapered-pin lengthwise joint 131 occurs as follows. The male 134 and female 136 ends of the longitudinal members 120 are joined with the aperture 135 of the tab member 137 positioned adjacent the tube sections 133. The pin member 150 is inserted through the tube sections 133 and the aperture 135 of the tab member 137. The tolerance between the aperture 135 and the non-tapered portion 158 of the pin member 150 is very tight and, in one embodiment, on the order of three one-hundredths (0.030) inches or less. In general, the tolerance is sufficiently tight to require a press (or hammer) to engage the non-tapered portion 158 of the pin member 150 with the aperture 135 of the tab member 137. The collar members 153 are then seated between the tapered portions 151 of the pin member 151 and the tube sections 133. In one embodiment, the inside surface 154 of each collar member 153 is dimensioned smaller than the outer dimension of the tapered portion 151 of the pin member 150, thereby preventing full insertion of the collar member 153 over the tapered portion 151 of the pin member 150. In this same embodiment, the outside diameter of the collar member 153 is but slightly less than the inside diameter of the tube sections 133. The washers 155 are then placed adjacent the ends of the pin member 150 and the bolts 156 inserted into the threaded holes 157. The bolts 156 are then threaded completely into the threaded holes 157, which forces the collar members 153 onto the tapered portions 151 of the pin member 150. As each collar member 153 is forced onto its respective tapered portion 151 of the pin member 150, the outside surface of the collar member 153 expands against the inside surface of its respective tube member 133.

Referring now to FIG. 6, when fully expanded by complete threading of the bolt 156 into its respective threaded hole 157, the outside surface of each collar member 153 is tightly engaged with the inside surface of the respective tube section 133, while the inside surface of each collar member 154 is tightly engaged with its respective tapered portion 151 of the pin member 150. In one embodiment, each collar further includes an inside edge 160 that abuts a respective side 161 of the tab member 137 to assist in preventing any side to side movement of the tab member 137 with respect to the tube sections 133 or female end 136 of the longitudinal joint 131. In further embodiments, a thread fastener, such as Loctite®, can be used to better secure the bolts 156 to the pin member 150 or, alternatively, welding may be used to permanently secure the assembled pin assembly 132. In similar fashion to the foregoing description, a second pin assembly 142 may be used to secure each diagonal member 126 to its respective longitudinal member 120 at each diagonal joint 141.

The foregoing descriptions for the connections at the lengthwise and diagonal joints 31, 41 131 are illustrative of the principle features of using pins having tight tolerances to secure the various longitudinal and diagonal members to one another. Those having skill in the art will, however, appreciate that any joint located in the structural tower is capable of being secured by the pin assemblies just disclosed or variations thereof. Furthermore, those skilled in the art will recognize that other modes of securing the joints are available. For example, flanges may be welded to opposing ends of longitudinal members, with the flanges connected to one another using a series of bolts. Alternatively, the pins discussed above may be substituted using bolts. Alternatively again, the connections can be made using welds, or a combination of welds, bolts and pins. The essential feature of the joint connections, regardless of the method chosen to secure the connection, is that the joints be tight when the connection is completed. There must be no, or minimal, relative translation, slip, or out of plane twisting movement occurring between the various longitudinal, diagonal and horizontal members once connected at the various joints and the pin joints must exhibit the same but may allow rotation of the connecting members around the central axis of the pin when the tower is being structurally loaded.

Referring again to FIG. 1, the structural tower 10 is illustrated as having eleven bay assemblies 12—e.g., a top bay assembly 19, a bottom bay assembly 13, and a series of intermediary bay assemblies 12 which, in broad sense, includes the top and bottom bay assemblies. The lowermost bay assembly 13 has a diameter relatively greater than the uppermost bay assembly 19. The upper bay assemblies 12 are smaller in diameter primarily to accommodate the wind turbine 14 and rotor blades 16. The smaller diameter of the upper bay assemblies permit unhindered rotation of the rotor blades 16 and allows the wind turbine 14 and rotor blade 16 combination to rotate completely about the central axis of the structural tower 10 to accommodate varying wind directions. The lowermost bay assembly 13 and those adjacent or otherwise near it are relatively larger in diameter to accommodate a larger footprint near the foundation 11 and, thereby, to provide more lateral stability to the structural tower 10. Similar to the means for providing the other connection described above, the lowermost ends of the longitudinal members 20 (120) comprising the lowermost bay assembly 13 may be secured to the foundation 11 using welds, bolts or pin joints—e.g., the lowermost ends of the longitudinal members 20 (120) are secured to tab members (not illustrated) that extend upwardly from the foundation 11 using the same connection means described above for the lengthwise joint section 31 (131).

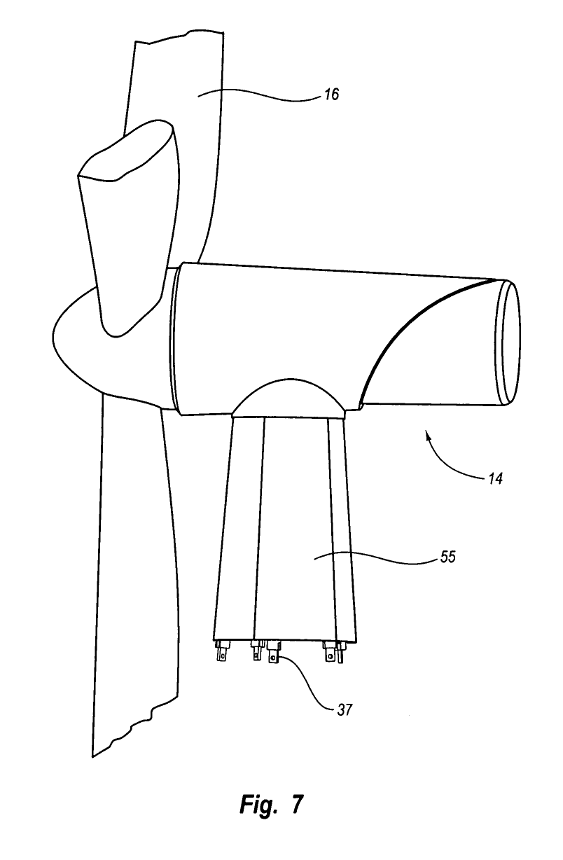

Referring now to FIG. 7, the wind turbine 14 is secured to a conventional tube-like cylindrical bay section 55. The cylindrical bay section 55 is in one embodiment constructed from steel and has a plurality of steel tab members 37 (137) extending downwardly. Each of the tab members 37 (137) is configured to interconnect with the upper ends of the longitudinal members 20 (120) of the upper most bay section 19. The connections are made using welds, bolts or the same pin connection means described above for the lengthwise joint section 31 (131). The wind turbine 14 is rotatably secured to the cylindrical bay section 55 using standard means or connection systems known by those skilled in the art for attaching wind turbines to conventional tube-type towers.

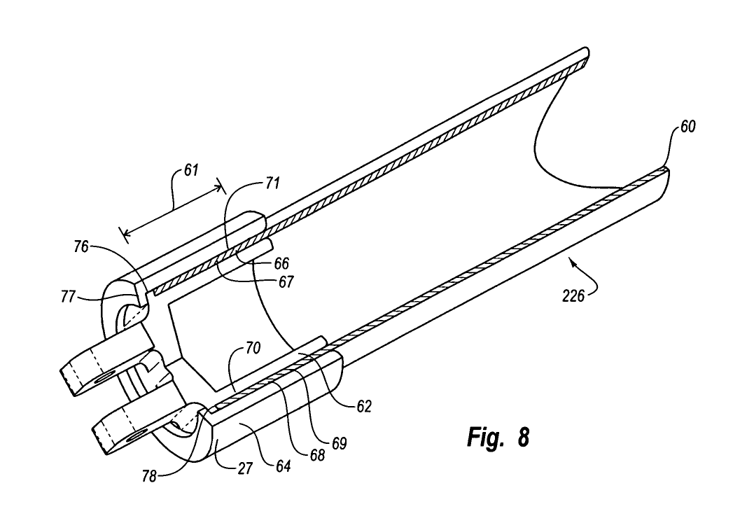

As discussed above, the use of materials other than steel to construct the various members that comprise the structural tower 10 may prove advantageous, particularly with respect to the longitudinal and diagonal members that comprise the bay sections 12 near the top of the tower. The use of composite materials, for example, to construct the diagonal or horizontal members substantially reduces the weight of the tower and can alter the stiffness characteristics and, hence, the resonant frequencies associated with the tower. Referring to FIG. 8, an embodiment of a composite diagonal member 226 of the present invention is described, together with means of securing such diagonal member 226 to respective adjacent longitudinal members. The diagonal member 226 is illustrated having a connector 27 of the present invention attached at one end. The diagonal member 226 includes a tubular member 60 of composite material. A connector 27 is secured at both ends of the tubular member 60. The connector 27 includes an inner sleeve 62 and an outer sleeve 64. The inner sleeve 62 provides an outside contact surface 66 at an outside diameter 67 of the sleeve. Similarly, the outer sleeve 64 provides an inside contact surface 68 at an inside diameter 69 of the sleeve. The tubular member 60 also provides an inside contact surface 70 and an outside contact surface 71 at both ends of the tubular member 60. The dimensions of the inner sleeve 62, the outer sleeve 64 and the tubular member 60 are selected to create an interference fit between the connector 27 and the tubular member 60 when assembled as described below. In one embodiment, the diameter of the inside contact surface 70 of the tubular member 60 is about ten inches, while the diameter of the outside contact surface 71 of the tubular member 60 is about eleven and one-half inches, resulting in a wall thickness of about one and one-half inches. In this embodiment, a negative tolerance of about ten to twenty one-hundreds (0.010-0.020) inch is preferred. Consistent with the foregoing contact surface diameters, then, the inside diameter 69 of the outer sleeve is in one embodiment about eleven and forty-eight to forty-nine hundreds (11.48 to 11.49) inches, while the outside diameter 67 of the inner sleeve 62 is about ten and one to two hundreds (10.01 to 10.02) inches. The length of the tubular member 60 of the structural tower 10 is in this embodiment ranges from about three to about eight meters, depending on its location in the tower. The axial length 61 for each of the various contact surfaces 66, 68, 70, 71 in this embodiment is about four to about six inches. The foregoing dimensions are used in this embodiment for diagonal members 226 positioned at the upper bay assemblies for the structural tower 10. The dimensions may, however, increase or decrease depending on the height, diameter and expected loading or operational conditions for any particular application of the structural tower.

One method for assembling the connector 27 to a composite tubular member 60 is described as follows. The outer sleeve 64 is heated to a temperature sufficiently high to expand the inside contact surface 68 so as to receive the outside contact surface 71 of the tubular member 60. Similarly, the inner sleeve 62 is chilled to a temperature sufficiently low to shrink the outside contact surface 66 so as to receive the inner contact surface 70 of the tubular member 60. In one embodiment, the outer sleeve 64 is heated to a temperature of about three hundred degrees Fahrenheit (300° F.), which is high enough to affect the desired expansion of the inside contact surface 68, but not so high as to cause damage to the composite matrix of the tubular member 60 when the sleeve and member are joined. At the same time, the inner sleeve 62 is cooled to a temperature of about minus three hundred fifty degrees Fahrenheit (−350° F.). When the desired temperatures are reached for the inner sleeve 62 and outer sleeve 64, the components are then joined together and allowed to equilibrate to room temperature. Once the temperature equilibrates, the outer and inner sleeves clamp the composite tubular member 60 with very high radial pressure or stress, forming an interference fit at the contact surfaces capable of transmitting tremendous loads in both compression and tension.

One embodiment of the connector 27 includes an outwardly extending lip portion 76 on the inner sleeve 62 and an inwardly extending lip portion 77 on the outer sleeve 64. The lip portion 76 on the inner sleeve 62 extends over the circumferential wall region 78 of the tubular member 60. Similarly, the lip portion 77 of the outer sleeve 64 extends approximately the same distance as the lip portion 76 of the inner sleeve 62, but in the opposite direction. The overlapping lip portions 76, 77 of the inner and outer sleeves 62, 64 serve to better distribute the frictional loads between the inner and outer contact surfaces of the tubular member 60 when the composite diagonal member 226 is placed under tension. Similar to the means for providing the connections described above, the connectors 27 of the composite diagonal members 226 are secured to the longitudinal members 20 (120) using bolts, welded, or pin joints—e.g., the same pin connection means described above for the diagonal joint sections 41 (141).

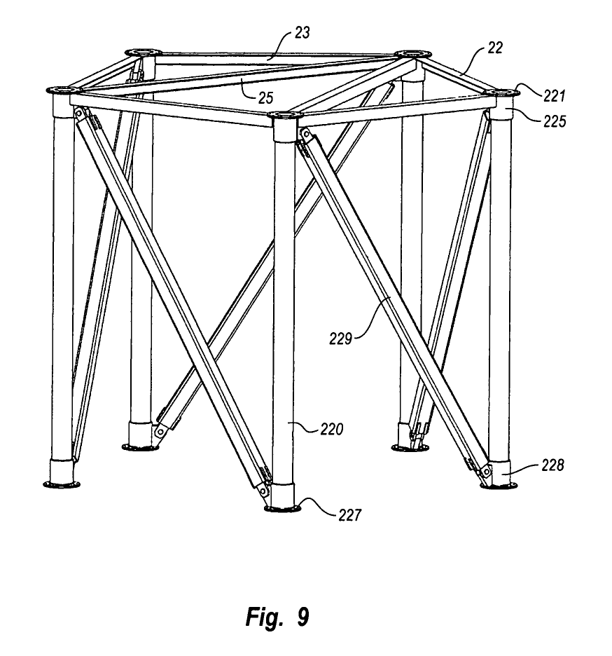

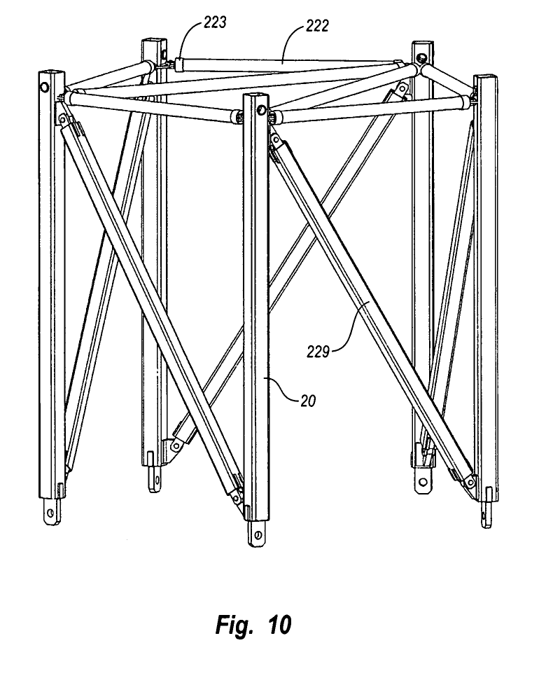

The foregoing description of the use of composite tubular members 60 in the construction of the structural tower 10 of the present invention focuses on the use of such composite members 60 in the composite diagonal members 226. The same principles apply generally to both the longitudinal and horizontal members as well. For example, FIGS. 9 and 10 illustrate composite tubular members being used to construct composite longitudinal members 220 and composite horizontal members 222, respectively, to achieve similar weight reduction benefits. The substitution of composite members for the steel members described above may be made selectively throughout the structural tower 10—i.e., to any one or more, or to even all, of the longitudinal, diagonal and horizontal members, without regard to their location in the structural tower 10. For example, FIGS. 9 and 10 illustrate the substitution of composite members—similar to the composite diagonal members 226 discussed above—for the longitudinal members 20 and the horizontal members 22 appearing in a typical bay assembly 12, respectively.

Referring to FIG. 9, for example, composite longitudinal members 220 are shown as composite struts having end connectors 225. The end connectors are secured to the composite longitudinal members 220 in a manner similar to that described above with respect to the interference fit connector 27 for the composite diagonal members 226. Rather than having a pair of end flanges 44, however, the end connector 225 has a flange 221 that is bolted or welded to a corresponding flange of an opposing end connector 225. Alternatively, the end connector 225 includes male and female tab configurations similar to those above described that enable the connection to be secured using bolts or a pin connection assembly as above described with reference to the longitudinal joint 31 (131). In similar fashion, FIG. 10 illustrates composite horizontal members 222 having end connectors 223 that are pinned, bolted or otherwise secured to steel longitudinal members 20. In both FIGS. 9 and 10, the diagonal members 229 are steel members, or alternatively composite diagonal members 226, that are pinned to the longitudinal members 20 or the end flange 225 using the techniques described above for constructing the diagonal joint 41 (141). As illustrated in FIG. 9, however, where composite longitudinal members 220 are used, it is preferable to secure the diagonal members 26 (226) directly to the end flanges, as opposed to the composite tubular members. Although FIGS. 9 and 10 illustrate bay sections having either composite longitudinal members 220 or composite horizontal members 222, respectively, it must be appreciated that further embodiments contemplate the entire structural tower 10 being constructed using composite longitudinal 220, diagonal 226 and horizontal 222 members, or any combination thereof.

In further embodiments of the present invention, incorporation into the structural tower 10 of one or more longitudinal, diagonal or horizontal members that are configured to damp vibrations—e.g., viscous or viscoelastic damping members or, more generally, damping members or struts—provides enhanced structural integrity to the tower under normal, and in response to extreme, operating conditions, particularly where large height wind turbine applications are concerned. Various embodiments of damping (or damped) struts or members are discussed herein. The discussions focus broadly on two classes of damping struts. The first class considers the use of viscoelastic materials in conjunction with composite or other stiff members to form a parallel spring and dashpot arrangement integral to one strut such that the damping member includes significant stiffness and damping. The second class considers the use of viscous or hydraulic fluid dampers arranged integral to a member to form a parallel spring and dashpot arrangement to include significant stiffness and damping. Alternatively, removal of the stiffness providing member results in a dashpot that provides primarily damping. While other means for affecting damping—e.g., magnetism—are known to those skilled in the art, the classes described herein have proved beneficial for use in high elevation wind turbine applications for the structural tower 10 of the present invention. Their discussion should not, however, be construed as limiting, or otherwise excluding the use of similar damping mechanisms having dashpot properties from falling within, the scope of the present invention. Furthermore, the discussion proceeds with a description that is directed primarily at damped diagonal members. From the discussion above, however, it must be appreciated that such description applies generally to longitudinal and horizontal members as well and, therefore, the description with respect to damped diagonal members should not be construed as limiting the scope of the invention, as the principals described herein and above apply generally to each of the longitudinal, diagonal and horizontal members of the structural tower 10.

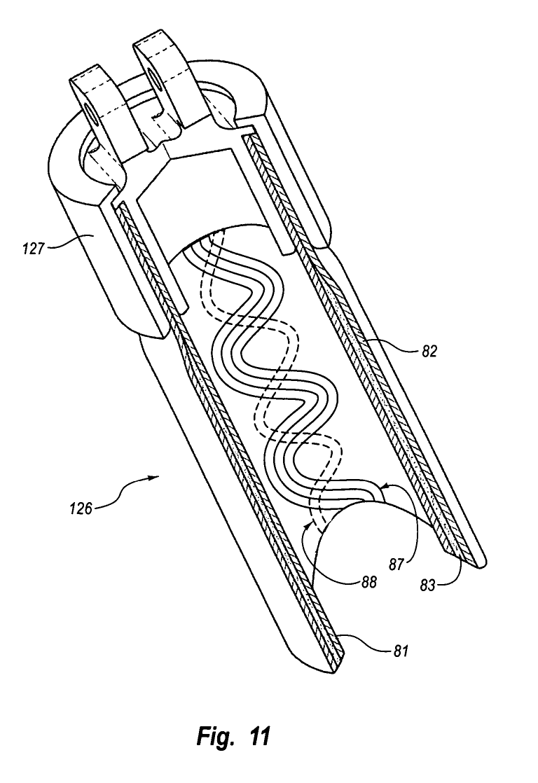

Referring now to FIG. 11, one embodiment of a damped diagonal member 126 is illustrated having a connector 127 of the present invention attached at one end. The embodiment illustrated in FIG. 11 includes an inner tubular member 81 and an outer tubular member 82. The inner and outer tubular members 81, 82 are in one embodiment constructed of composite fiber materials having the fibers layered in distinct patterns. Sandwiched between the inner and outer composite tubular members 81, 82 is a layer of viscoelastic material 83. The combination of the viscoelastic layer 83 sandwiched between the inner and outer tubular members 81, 82 provides a composite damping strut for damping vibrations of the structural tower 10. The connector 127 is secured to the combination of inner and outer tubular members 81, 82 and viscoelastic layer 83 in the same manner described above respecting the interference fit for the composite diagonal member 226 having a single composite tubular member 60. The dimensions for the damped diagonal member 126 may be the same as those for the composite diagonal member 226 described above. The thickness of the viscoelastic layer is relatively small—in one embodiment on the order of about two tenths millimeter (0.2 mm)—compared to the wall thickness of the composite tubes which, consistent with the previously described diagonal member 226, are about three-quarter inch each, giving a total wall thickness of about one and one-half inches. Further, the viscoelastic layer in this embodiment does not extend into the connector region. If desired, a very thin axial collar of suitable material, such as composite, on the order of the thickness of the viscoelatic layer, may extend into the connector region rather than extending the viscoelastic layer into the connector region. This latter arrangement will be beneficial for embodiments where the thickness of the viscoelastic layer is on the order of one millimeter or greater.

The use of composite damping members (or struts) to damp vibrations has been proposed in U.S. Pat. No. 5,203,435 (Dolgin), the disclosure of which is incorporated herein by this reference. Methods of making the composite damping struts are also disclosed in U.S. Pat. No. 6,048,426 (Pratt), U.S. Pat. No. 6,287,664 (Pratt), U.S. Pat. No. 6,453,962 (Pratt) and U.S. Pat. No. 6,467,521 (Pratt), the disclosures of which are also incorporated herein by this reference. The composite damping struts of the present invention—e.g., damped diagonal member 126—are constructed with the following structural and functional properties. The inner and outer composite tubular members 81, 82 are manufactured so that the lay of the fiber matrix in the tubes follows defined patterns, with the pattern of the inner tubular member 81 being out of phase with the pattern of the outer tubular member 82. Particularly useful patterns include sine waves having constant or varying frequencies and amplitudes along the axial length or loading direction of the members. Alternate patterns include saw-tooth (or V-shaped) waves and helical spirals. One feature of the patterns is that at least a portion of the pattern on the inner tube is out of phase with the pattern on the outer tube or is phase shifted with respect to the pattern on the outer tube. This causes shear stresses in the viscoelastic layer 83 to be generated when the composite strut is loaded in either compression or tension. The shear stresses produce internal friction within the viscoelastic layer which generates heat that later dissipates to the environment, thereby affecting damping of the structural tower 10 through use of damping struts—e.g., through the use of damped diagonal members 126. Alternative embodiments for the patterns in the inner and outer tubes include any patterns that affect a shear stress within the viscoelastic layer upon the application of compressive or tensile forces at the ends of the damping strut. The alternative patterns may be generated, for example, by the laying of composite fibers running in the axial, helical or hoop (or circumferential) directions of the composite tubular members 81, 82.

Referring still to FIG. 11, the inner tubular member 81 includes a first pattern of composite (or reinforcing) fibers 87. The first pattern of reinforcing fibers 87 extends radially about the inner and outer circumference of the tube (as well as inside the thickness of the tube) and axially along the length of the tube. In one embodiment, the first pattern of reinforcing fibers 87 is in the form of a sine wave having a constant wavelength (or frequency) and amplitude (only a portion of the pattern is illustrated). The outer tubular member 82 includes a second pattern of reinforcing fibers 88. The second pattern of reinforcing fibers 88 is also in the form of a sine wave having a constant wavelength and amplitude (a portion of the second pattern is shown superimposed on the inner tubular member using dotted lines). Other patterns may be used without departing from the scope of the present invention. Both the first and second patterns of reinforcing fibers 87, 88 are in one embodiment 180 degrees out of phase with one another along the complete length of the tubular members 81, 82. It will be appreciated by those skilled in the art, however, that the patterns need not be completely 180 degrees out of phase. Further, it will be appreciated that the viscoelastic layer need only reside along a portion of the length for damping to occur. When the damped diagonal member 126 is loaded in compression or tension, the peaks and troughs and other portions of the sine wave patterns move with respect to each other, thereby affecting shear stresses in the viscoelastic layer and the resultant damping of vibrations. Those skilled in the art will recognize, however, that any pattern of composite fiber will affect shear stresses within the viscoelastic layer and resultant damping—the greater the shear stress, however, the greater the damping.

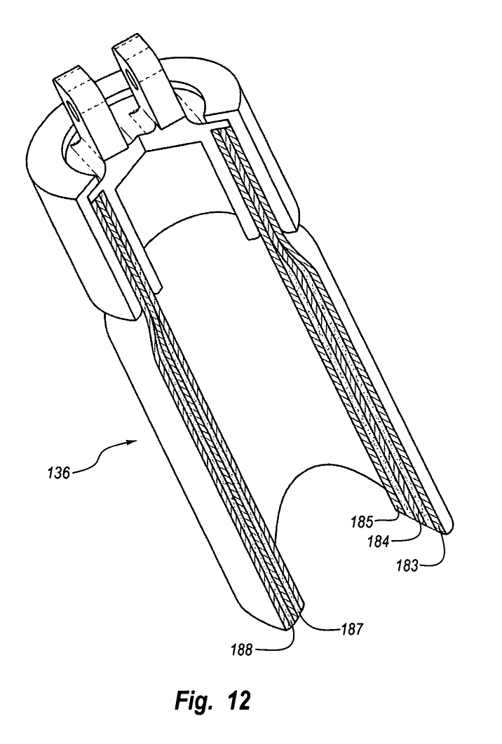

Although FIG. 11 illustrates a single layer of viscoelastic material sandwiched between a pair of composite tubular members, it will be apparent to those having skill in the art that additional layers of viscoelastic material and composite tubular members may also be used to affect damping. Referring to FIG. 12, for example, an alternative to the composite damping strut above described is illustrated. Specifically, an alternative composite damping strut 136 includes a first composite tubular member 183, a second composite tubular member 184 disposed within the first, and a third composite tubular member 185 disposed with the second. A first viscoelastic layer 188 is disposed between the first and second composite tubular members 183, 184, and a second viscoelastic layer is disposed between the second and third composite tubular members 184, 185. The first composite tubular member 185 includes a first pattern of reinforcing fibers (not illustrated) extending hoop-wise or circumferentially about the circumference and axially along the length of the tube. The first pattern of reinforcing fibers is in one embodiment in the form of a sine wave having a constant wavelength (or frequency) and amplitude. The second composite tubular member 184 includes a second pattern of reinforcing fibers that is in one embodiment out of phase with the first pattern of reinforcing fibers. The third composite tubular member 183 includes a third patter of reinforcing fibers that is in one embodiment out of phase with the second pattern of reinforcing fibers (and maybe completely in phase with the first pattern of reinforcing fibers, if desired). When the composite damping strut—e.g., the alternative diagonal member 136—is loaded in compression or tension, the peaks and troughs and other portions of the sine wave patterns shift positions with respect to each other, thereby affecting shear stresses in the viscoelastic layers and causing the resultant damping of vibrations. Consistent with the previous embodiment, those skilled in the art will recognize, however, that any patterns of composite fibers among the various tubular members will affect shear stresses within the viscoelastic layer and resultant damping—the greater the shear stress, however, the greater the damping.

As mentioned already, the foregoing description of the use of damped composite members in the construction of the structural tower 10 of the present invention focused on the use of such composite members in the diagonal members 126, 136. The same principles apply, however, generally to both the longitudinal and horizontal members as well. Accordingly, the discussion above respecting the use of composite tubular members to construct longitudinal and horizontal composite members, as illustrated in FIGS. 9 and 10, applies equally to the construction of damped longitudinal and horizontal composite members. Furthermore, the substitution of damped composite members for the steel (or non-viscoelasticly damped composite) members described above may be made selectively throughout the structural tower 10—i.e., to any one or more, or to even all, of the longitudinal, diagonal and horizontal members, without regard to their location in the structural tower 10.

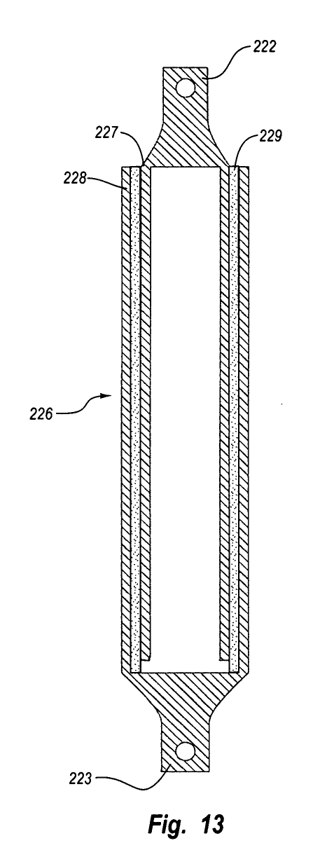

Various alternative embodiments or systems for damping the structural tower 10 are contemplated as falling within the scope of the present invention. Referring to FIG. 13, for example, an alternative damping strut 226 is shown. The damping strut 226 includes an inner tubular member 227, an outer tubular member 228 and a viscoelastic (or rubber-like) material 229 disposed between the inner and outer tubular members 227, 228. The inner and outer tubular members 227, 228 are constructed using composite materials having fibers laid in patterns as discussed above. Suitable alternatives may include steel, aluminum or plastic, having patterns that are similar to those described above inscribed on the surfaces surrounding the viscoelastic layer. Alternatively, no patterns at all may be used, resulting in a lower degree of shear stress and lower degree of resultant damping. The inner and outer tubular members 227, 228 include connector segments 222, 223 for connecting the damping strut 226 to the longitudinal members 20 of the structural tower 10 in the manner described above. The inner and outer tubular members 227, 228 are free to translate in the axial direction with respect to one another as the damping strut 226 undergoes tension or compression. As the damping strut undergoes tension or compression, shear stresses in the viscoelastic material occur, generating heat that is dissipated to the environment, thereby affecting damping in the structural tower 10.

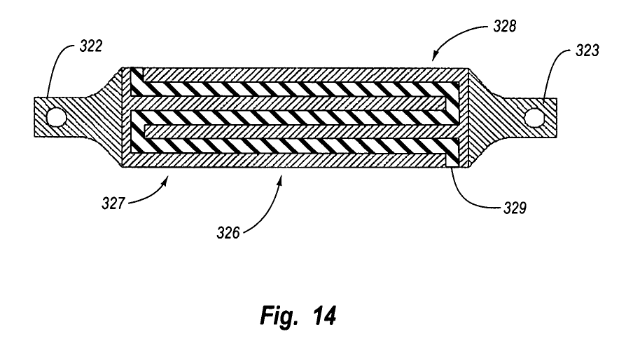

Referring to FIG. 14, a further alternative to the damping strut of the present invention is shown. The alternative damping strut 326 includes a pair of plate members 327, 328 enmeshed together and sandwiching layers of viscoelastic (or rubber-like) material. The plate members 327, 328 are constructed using composite materials having fibers laid in patterns as discussed above; except here the patterns appear on essentially planar surfaces as opposed to an axial surface. Suitable alternatives include steel, aluminum or plastic, having patterns inscribed on the contact surfaces. Connector segments 322, 323 secure the damping strut 326 to the longitudinal members 20 of the structural tower 10 in the manner described above. The plate members 327, 328 are confined by suitable means (not illustrated) to translate in the longitudinal direction with respect to one another as the damping strut undergoes tension or compression. As the damping strut undergoes tension or compression, shear stresses in the viscoelastic material occur, generating heat that is dissipated to the environment, thereby affecting damping in the structural tower 10.

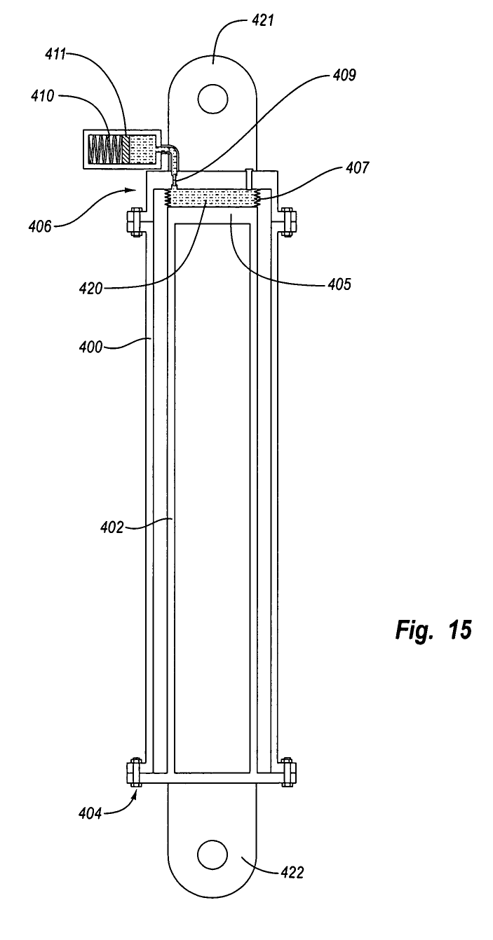

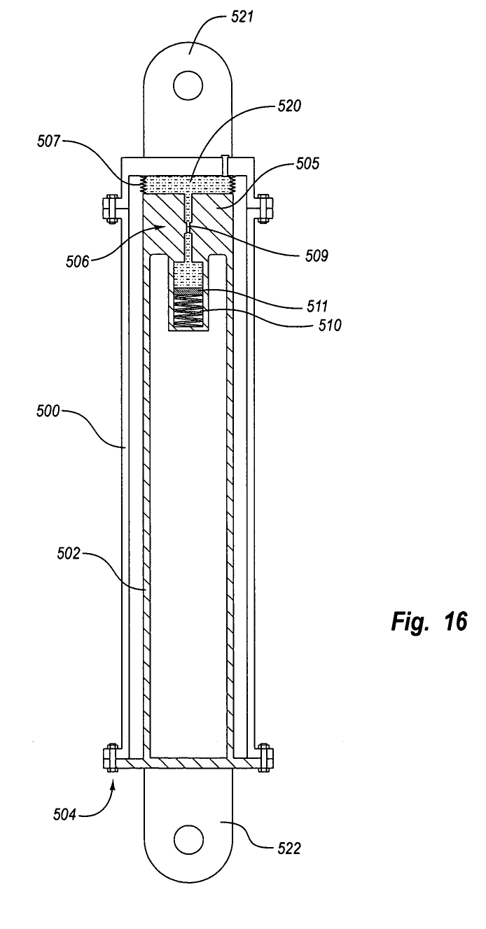

Various other alternative damping embodiments may be used to damp vibrations in the structural tower 10 of the present invention. For example, viscous or hydraulic means as applied in the d-strut technology developed for use in precision truss structures may be used to damp vibrations. The “d-strut” technology is described in, for example, Anderson et al., “Testing and Application of a Viscous Passive Damper for Use in Precision Truss Structures,” pp. 2796-2808 (AIAA Paper, 1991), the disclosure of which is incorporated herein by this reference. The d-strut technology employs a viscous or hydraulic damper configured in an inner-outer tube strut arrangement. Referring to FIGS. 15 and 16, for example, an outer tubular strut 400 (500) is constructed of a material such as aluminum, while an inner tubular strut 402 (502) is constructed of a material having a higher stiffness or modulus of elasticity than the outer strut. The larger the difference in the effective stiffness (or cross sectional area multiplied by the modulus of elasticity) between the inner and outer struts 400, 402 (500, 502), the more damping that is achieved. A dashpot may be derived from the foregoing two embodiments—i.e., those illustrated in FIGS. 15 and 16—by removing the stiffness providing outer tubular struts 400 (500), thereby reducing the effective stiffness of the damping members to near zero and with the resulting member affecting primarily dampening. In one embodiment, the inner strut 402 (502) is connected to the outer strut 400 (500) at a common end 404 (504). The opposite end 405 (505) of the inner strut 402 (502) is attached to a viscous or hydraulic damper 406 (506), which includes a bellows assembly 407 (507) or other flexible member, a small orifice 409 (509), and a spring member 410 (510) and piston 411 (511) arrangement or similar accumulator device. The ends of the outer strut 400 (500) are connected to longitudinal members 20 through end connectors 421, 422 (521, 522) using, for example, the techniques described above respecting diagonal joints 41, 141 or other suitable means. Under compressive or tensile loads, the outer strut 400 (500) is strained in the axial direction causing a relative displacement between the inner and outer struts, and thereby activating the viscous or hydraulic damper 406 (506). Fluid 420 (520) moving through the small orifice 409 (509) creates shear forces within the viscous fluid which, in turn, provides damping for the structural tower 10. The accumulator portion of the viscous or hydraulic damper—e.g., the spring member 410 (510) and piston 411 (511)—may be located either within the d-strut as illustrated in FIG. 16 or outside the d-strut as illustrated in FIG. 15. Alternatively, the accumulator portion of the viscous or hydraulic damper 406 (506) may be positioned between the inner and outer struts 400, 402 (500, 502). Those skilled in the art will recognize that the spring and piston portion of the damper is an accumulator that can be substituted with similar hydraulic accumulators as are readily known, and will further recognize that the tension on the spring 410 or the gas charge pressure for gas accumulators must be sufficiently great to reduce air bubbles from forming in the fluid to prevent reduction in damping under tensile loads.

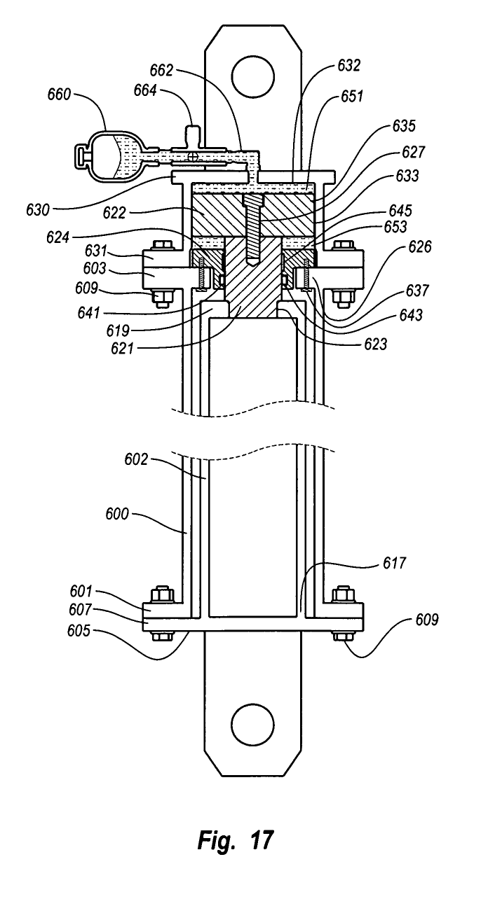

Referring now to FIG. 17, a further embodiment of a viscous damping strut or member is illustrated. An outer tubular strut 600 houses an inner tubular strut 602. Similar to the d-strut embodiments described above, the outer tubular strut 600 is constructed of a material such as aluminum, while the inner tubular strut 602 is constructed of a material having a higher stiffness or modulus of elasticity—e.g., steel—than the outer strut. The larger the difference in the effective stiffness (or cross sectional area multiplied by the modulus of elasticity) between the inner and outer struts 600, 602, the more damping that is achieved. Those skilled in the art will recognize that an alternative arrangement to create only a dashpot includes, in essence, removal of outer tubular strut (600). The outer strut 600 has a first end 601 and a second end 603. An end cap 605 has a flange member 607 that is configured to engage a complementary flange member positioned at the first end 601 of the outer strut 600. A series of bolts 609 are used to tightly secure the end cap 605 to the first end 601 of the outer strut 600. The inner strut 602 has a first end 617 that is secured to the end cap 605 using any suitable means, such as, for example, welding. The inner strut has a second end in the form of a second flange 619 that is itself attached to a connecting rod 620. A first end of the connecting rod 620 is secured to the second flange 619 using any suitable means, such as, for example, a threaded male portion 621 of the connecting rod threaded onto a corresponding female threaded portion 623 of the flange 619.

A second end cap 630 has a flange member 631 that is configured to engage a complementary flange member positioned at the second end 603 of the outer strut 600. A series of bolts 609 are used to tightly secure the second end cap 630 to the second end 603 of the outer strut 600. A seal housing 624 is secured to an inner portion 626 of the flange member positioned at the second end 603 of the outer strut 600. The seal housing 624 is secured to the inner portion 626 of the flange member using a series of bolts 637 or other suitable means. The seal housing has an inner wall surface 643 that is closely machined to match an outer wall surface of the connecting rod 620. A seal 641 is positioned between the connecting rod 620 and the seal housing 624 to prevent damping fluid—e.g., viscous or hydraulic fluid—from leaking along the interface that exists between the two components. A polymer-like wear band 645 can be placed between the seal housing 624 and the connecting rod 620 to prevent wear of the components due to relative movement of the two parts. Alternatively, the diameter of the inner wall surface 643 can be increased such that a gap is created between the inner wall surface 643 and the outer wall surface of the connecting rod 620. The gap created by the separation can be filled with a compliant mechanism, such as, for example, a bellows or a rubber material that is bonded both to the connecting rod 620 substantially along its length and also to the seal housing 624, thus eliminating the need for the seal 641. This compliant material alternative is particularly beneficial for use in the damping strut where small displacements occur on the order of less than 1 inch, as the non-rigid material can stretch to accommodate the relative movement. The elimination of the seal 641 also provides a non-sliding surface to seal the fluid thus providing extended life characteristics. A piston 622 is secured to a second end of the connecting rod 620 using a bolt 627 or a series of bolts. The second end cap 630 has an inner wall surface 633 that is closely machined to match an outer wall surface 635 of the piston 622.

Damping fluid 650 (e.g., viscous or hydraulic fluid) is contained in a first cavity 651 and a second cavity 653 that are formed by the piston 620, the second end cap 630 and the seal housing 624. Damping occurs when the piston 620 translates toward or away from a base portion 632 of the second end cap 630 due to the relative displacement between the inner 602 and outer 600 struts when the damping strut undergoes compressive or tensile loads. More specifically, when the piston 620 translates toward the base portion 632, fluid from the first cavity 651 is forced into the second cavity 653 through a circumferential region defined by the space between the inner surface wall 633 of the second end cap 630 and the outer surface wall 635 of the piston 620. Alternatively, small conduits or holes can be machined through the main body of the piston 620 from one face to the other, whereby damping occurs when the fluid flows from one side of the piston 620 to the other via one or more of the small conduits. An accumulator 660 is connected to the first cavity via a duct 662. Alternatively, the accumulator 660 may be located internally at various locations inside the strut and the duct 662 may be connected to the second fluid cavity 653. The accumulator 660, or a similar device, is required to accommodate the volume of space that the body of the connecting rod 619 occupies in the second cavity 653. More specifically, as the piston 620 translates a distance toward the base portion 632, the volume of the first cavity 651 will be reduced and the volume of the second cavity 653 increased. Because of the presence of the connecting rod 619 in the second cavity 653, however, the volume of fluid that is displaced from the first cavity 651 is greater than the volume of space that is generated in the second cavity 653 due to the translation of the piston 620. The excess fluid, equal in volume to the volume of space in the second cavity 653 that is occupied by the connecting rod as the rod translates into the second cavity 653, is transferred through the duct 662 into the accumulator. A control valve 664 positioned between the first cavity 651 and the accumulator 660 serves to permit fluid flow into the accumulator during compression of the damping strut—i.e., where the piston 620 translates toward the base portion 632- and serves to permit fluid to escape the accumulator back into the first cavity 651 during tension of the damping strut—i.e., where the piston 620 translates away from the base portion 632. The foregoing descriptions of an accumulator to provide the additional fluid for the connecting rod 619 are illustrative of the principle features necessary to provide the make up fluid. Those having skill in the art will, however, will appreciate that other devices or mechanisms are known that can provide this fluid in correct proportions to effect proper operation.

As previously discussed, in one embodiment, the fluid 650 is transported from the first cavity 651 to the second cavity 653 and visa versa through the space between the inner surface wall 633 of the second end cap 630 and the outer surface wall 635 of the piston 620. As discussed below, this mode of fluid transport permits the damping strut to be less sensitive to temperature variations than if the fluid were transported through small conduits extending through the body of the piston. More specifically, damping efficiency may be affected by changes in temperature due to the attendant change in the viscosity of the damping fluid that occurs as a function of temperature. For example, as temperature increases, the viscosity of a damping fluid will generally decrease, leading to less efficient damping for a given displacement of the piston 620. This trend can be countered where the piston 620 is constructed using a material having a higher coefficient of thermal expansion than the material used to construct the second end cap 630 (or the cylinder wall adjacent the piston). In one embodiment, for example, the piston 620 is constructed using aluminum and the second end cap 630 is constructed using steel. Aluminum has a higher coefficient of thermal expansion than does steel, meaning that aluminum will expand and contract as a function of temperature at a rate larger than that of steel. This variance in thermal expansion rate causes the space between the inner surface wall 633 of the second end cap 630 and the outer surface wall 635 of the piston 620 to increase as the temperature drops relative to a specified design temperature and to decrease as the temperature increases relative to the specified temperature. The damping effect that occurs due to shear forces generated in a fluid between two moving surfaces depends in part on the space or distance between the surfaces—the greater the distance, the less the damping. Accordingly, as temperature increases, the decrease in damping efficiency due to the decrease in viscosity of the fluid is partially offset by the decrease in the space or distance between the inner surface wall 633 of the second end cap 630 and the outer surface wall 635 of the piston 620. This feature of the present invention is particularly beneficial in that it decreases the sensitivity of the damping strut due to variations in temperature that arise due to daily or seasonal variations in weather.

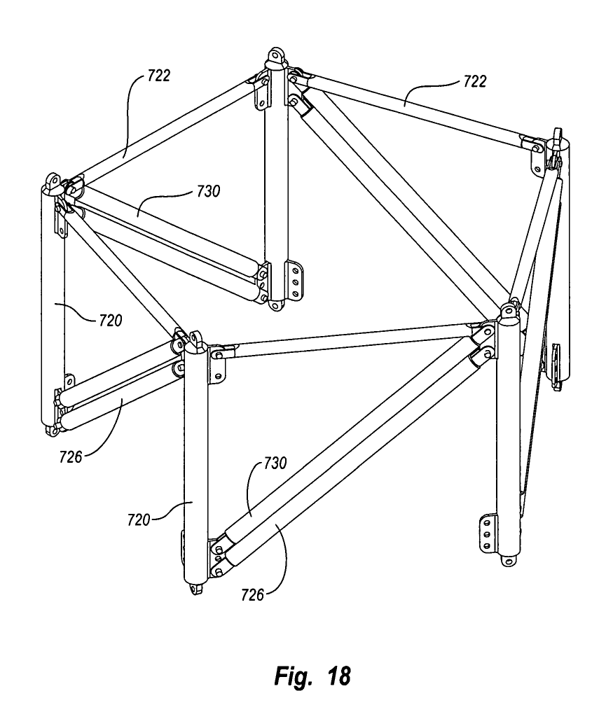

The foregoing description provides details concerning various modes and methods of constructing a structural tower that includes damped or undamped longitudinal, diagonal or horizontal members disposed in one or more bay assemblies of the structural tower. Those having skill in the art will, however, recognize various alternatives to the manner of assembly described above. For example, the bay sections 12 are illustrated as having a single diagonal member 26 disposed between pairs of longitudinal members 20 at each face of the bay section 12. Those skilled in the art will appreciate, however, that pairs of diagonal members 26 may be disposed between pairs of longitudinal members 20 in crosswise format, may be disposed between any pairs of longitudinal members across the interior of the tower space, and the orientation of the single mode diagonal members 26 can be mixed—i.e., the diagonal members may be disposed in both clockwise and counterclockwise direction (or right running and left running configurations as adjacent bay sections are sequenced along the central axis of the tower 10). Alternatively, diagonal members may be eliminated from individual faces of a bay assembly; longitudinal members may span one or more bay assemblies; and horizontal members may be selectively eliminated from one or more bay assemblies. Referring now to FIGS. 18-24, various other alternative embodiments of a structural tower including combinations of damped and undamped struts or members are illustrated and described. While these illustrations and descriptions are provided in generic form—i.e., certain details of the specific members are not illustrated—it must be appreciated that the details provided above with respect to the various constructions or applications of the various damped or undamped members are applicable to the various applications provided herein below.

Referring to FIG. 18, for example, an alternative embodiment of a bay assembly 712 is illustrated. The bay assembly 712 includes undamped—e.g., steel, aluminum or composite—longitudinal 720, diagonal 726 and horizontal 722 members constructed using one or more of the various embodiments above described. In one embodiment, the bay assembly 712 further includes a series of damped diagonal members 730 spaced adjacent and parallel to each of the undamped diagonal members 726. With respect to this embodiment, when the structural tower is subjected to loading, the undamped diagonal members 726 will experience a slight axial deflection due either to compressive or tensile loads experienced by the diagonal member 726. While the undamped diagonal member 726 experiences such deflection in the axial direction, the adjacent damped members 730 will likewise deflect axially, causing energy to be dissipated thereby. The arrangement of undamped and damped diagonal struts 726, 730 in this regard may be considered loosely analogous to a dynamically loaded one-dimensional spring and dashpot connected in parallel. While any of the various damping members described above can be employed for the damped diagonal members 730 illustrated in FIG. 18, alternative embodiments contemplate the use of large shock-absorbers (or dashpots) that provide nearly pure damping and very low stiffness. Indeed, those having skill in the art will recognize that the parallel side-by-side arrangement of a shock-absorber (dashpot) and stiff non-damping member is analogous to the damping members above described wherein each such member includes both a spring-like stiffness element (non-damping member) and a damping element—e.g., the outer tube member of the viscous damping members 400, 500, 600 provides the undamped stiffness component while the inner tube member 402, 502, 602 and hydraulic damper components provide the damping component. This discussion applies to the various other alternatives appearing below. Shock absorbing dashpots for primarily damping purposes—as opposed to the damping members or struts disclosed herein and having both spring-like and dashpot-like characteristics—are commercially available through, for example, Taylor Devices, Inc., North Tonawanda, N.Y.

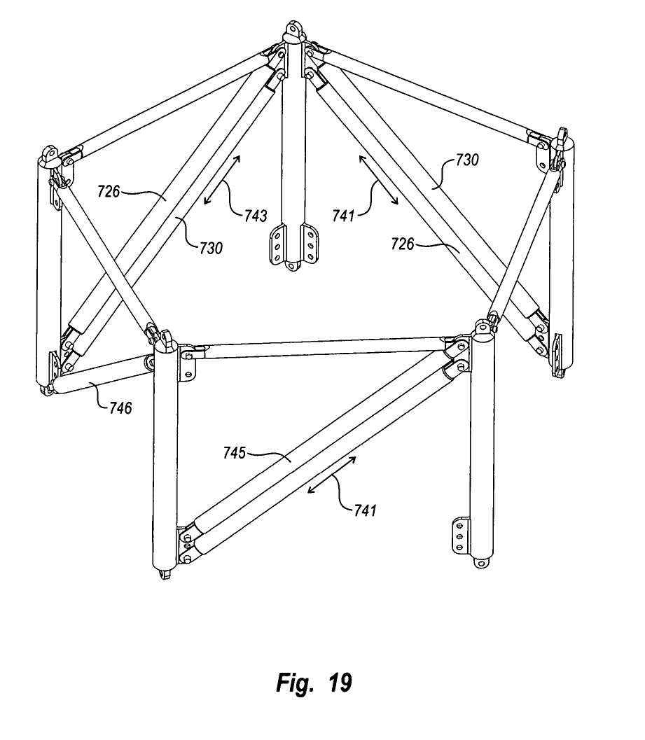

Referring now to FIG. 19, alternative embodiments to that illustrated in FIG. 18 contemplate damped diagonal struts 730 positioned above or below the adjacent undamped diagonal strut 726, and adjacent pairs of damped and undamped struts oriented in either of the clockwise 741 or counterclockwise 743 directions or combinations thereof. As further illustrated in FIG. 19, alternative embodiments of the bay assemblies contemplate the use of pairs of damped and undamped diagonal struts on one or more faces 745 of the bay assembly, while other faces 746, 747 of the bay assembly include one or the other of a damped or undamped diagonal strut or neither of a damped or undamped diagonal strut.

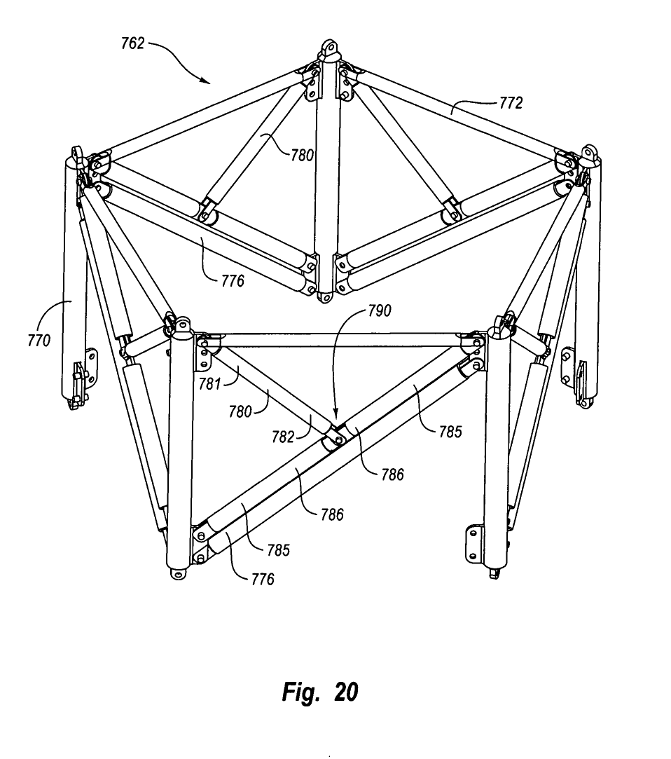

Referring now to FIG. 20, a still further alternative embodiment of the arrangement of struts in a bay section is illustrated. In this embodiment, the bay assembly 762 includes undamped longitudinal 770, diagonal 776 and horizontal 772 members constructed using one or more of the various embodiments above described. In one embodiment, the bay assembly 762 further includes a series of damped struts 780 spaced adjacent and substantially perpendicular to each of the undamped diagonal members 776. The damped struts 780 have first ends 781 connected to adjacent longitudinal members 770 and second ends 782 connected to a pair of amplification members 785, each of which is an undamped member that may be constructed using the methods and techniques described above. Each one of the pair of amplification members 785 is positioned at a angle—in one embodiment, from about five to about fifteen degrees—with respect to the adjacent diagonal member 776. The first ends 786 of the amplification members 785 and the second end 782 of the damping strut are coupled together at a hinge joint 790. With respect to this embodiment, when the structural tower is subjected to loading, the diagonal members 776 will experience a slight axial deflection due either to compressive or tensile loads experienced by the diagonal member 776. While a diagonal member 776 experiences such deflection in the axial direction, the hinge joint 790 connecting adjacent amplification members 785 and damping strut 780 will translate toward or away from the diagonal member 776, depending on whether the load is tensile or compressive, respectively. The translation of the hinge joint 790 results in axial defection of the damping strut 780 causing energy to be dissipated thereby.

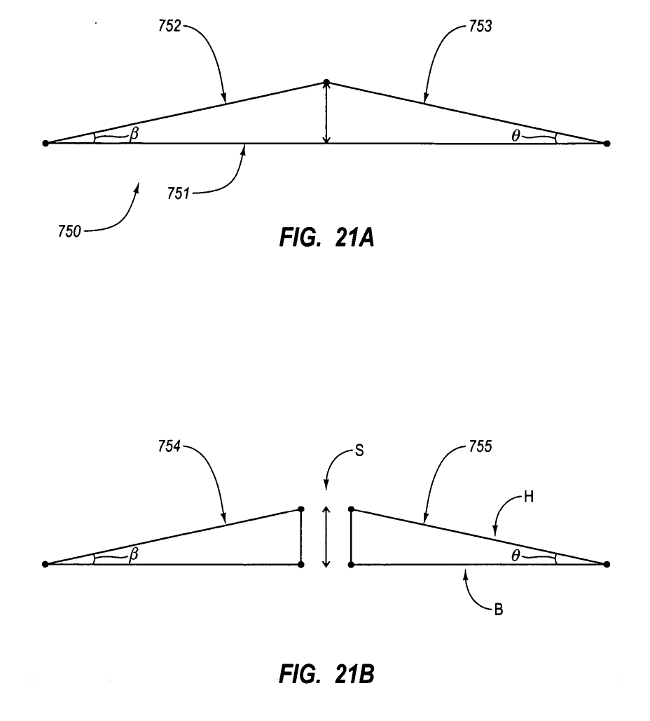

Referring now to FIG. 21A, the amplification effect that the amplification members 785 provide for damping is best understood with reference to Pythagoras' theorem for a right triangle. Specifically, a triangle 750 having a base 751 is illustrated. The base 751 of the triangle 750 may be associated with the undamped diagonal member 776 illustrated in FIG. 20. In similar fashion, the pair of amplification members 785 illustrated in FIG. 20 may be associated with the remaining two sides 752, 753 of the triangle 750 (which are not necessarily equal in length). The angles β and θ (which are also not necessarily equal) may be associated with the angles that each of the amplification members 785 lie with respect to the undamped diagonal strut 776. As illustrated in FIG. 21B, this arrangement provides two right triangles 754, 755, with each triangle having a hypotenuse H, base B and side S. Focusing on triangle 755, if the hypotenuse H is assumed substantially rigid, then a change in the length of base B due to a compressive or tensile load will result in a corresponding change in the length of side S. Basic algebra provides the following relation in this regard: dS/dB≈−(B/S)≈−(1/tan θ). Thus, for small initial S with respect to initial B (or small 0), the change in S will be relatively large compared to a change in B. In other words, a small axial deflection in the length of the undamped diagonal strut 776 will result in a relatively large axial displacement of the damping strut 780, provided the angle between them is small. In one embodiment, the amplification effect is ensured by constructing the amplification members 785 using a material having a relatively high elastic modulus such as steel and the undamped diagonal members 776 using a material having a relatively lower elastic modulus such as aluminum.

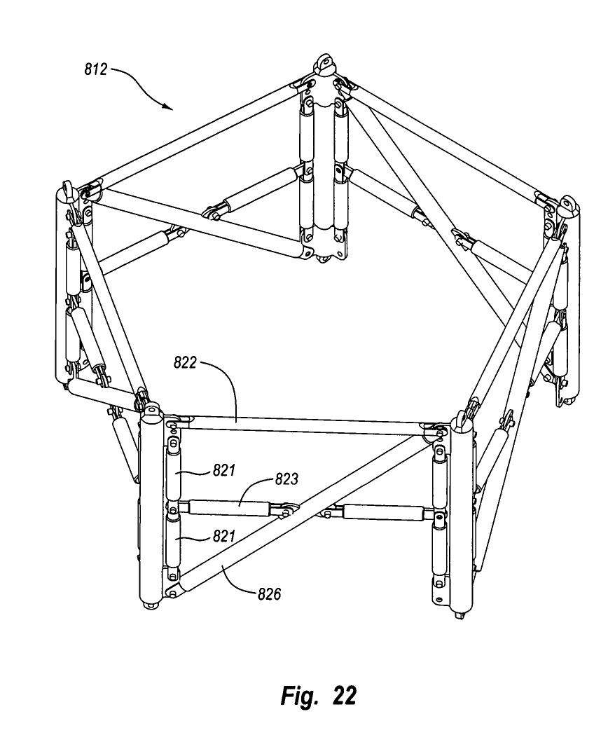

Referring now to FIG. 22, a further embodiment of a bay section 812 is illustrated. The bay section 812 includes undamped longitudinal 820, diagonal 826 and horizontal 822 members constructed using one or more of the various embodiments above described. The bay section 812 further includes amplification members 821 and damping struts 823. The amplification members 821 and damping strut 823 are constructed and function in similar fashion to those described above; excepting, however, the amplification members 821 are, in the illustrated embodiment, disposed adjacent longitudinal members 820 rather than diagonal members.

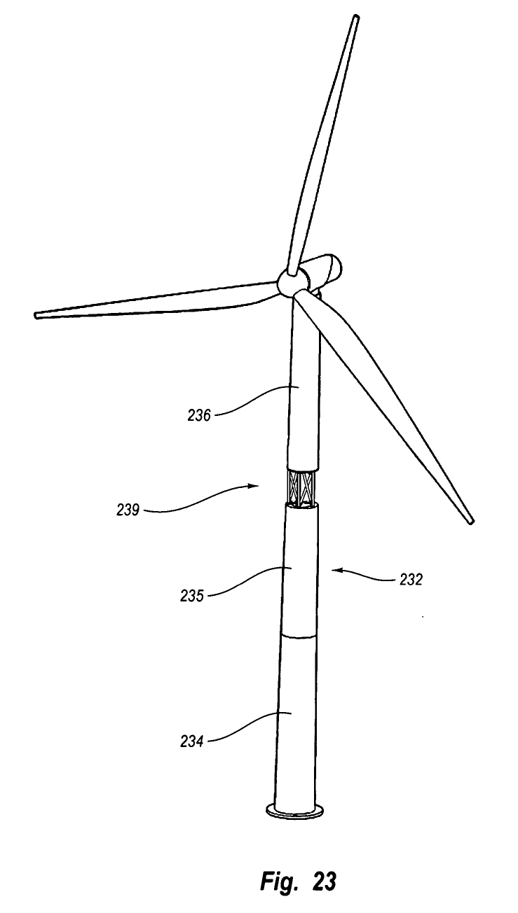

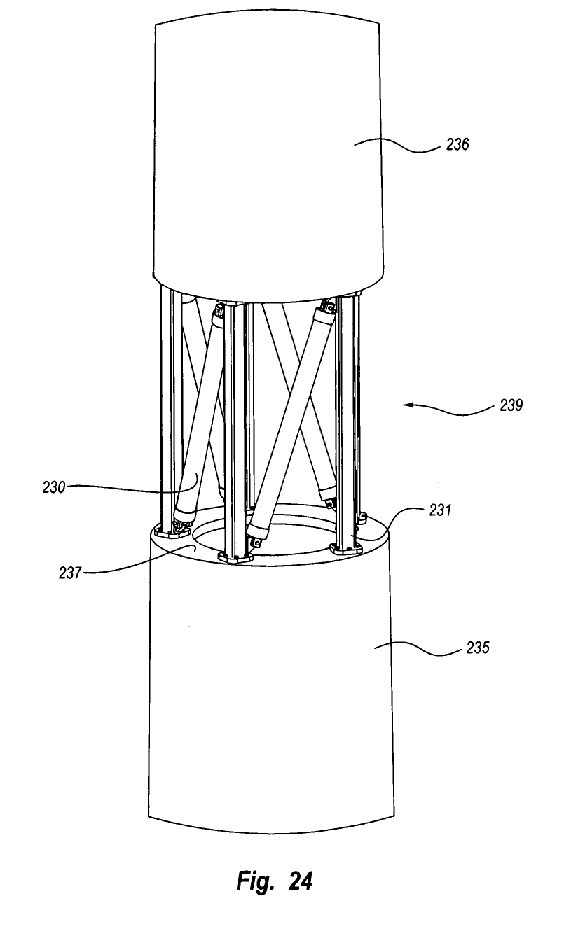

Referring now to FIGS. 23 and 24, a modified conventional tube tower 232 is illustrated having damping diagonal members 230 and steel longitudinal members 231. The modified conventional tower 232 has conventional tube members 234, 235 that are assembled in typical fashion. The upper steel or concrete tube member 235 has a steel ring or other suitable member that is configured to accept the ends of a plurality of longitudinal members 231. Diagonal struts—e.g., damping or non-damping diagonal struts or combinations of dashpots and spring elements—are secured to adjacent pairs of longitudinal members 231 using the manner described above respecting the pinned diagonal joints 41, 141 or other suitable means such as bolts, welds or flanges. Similar struts—e.g., damping or non-damping longitudinal struts or combinations of dashpots and spring elements—can be substituted for the longitudinal members 231 as well and be secured to the conventional tube members 234, 235 using any of the manners described above—e.g., using bolts, welds, pins or flanges. The uppermost tube member 236 is then secured to the upper ends of the longitudinal members 230. The strut bay assembly 239 is locatable anywhere in the tube tower, and can be covered with a steel tube shell (not illustrated), or other suitable material, e.g., aluminum, for esthetic or structural purposes if desired. Modified tube towers are also contemplated having any number of bay sections 239 placed throughout the tower. It will be apparent also that the structural tower 10 of the present invention may include tube sections substituted for one or more of the bay assemblies 12 of the present invention. Further it will be appreciated that any of the various embodiments described above or variations thereof can be included in constructing the bay assembly 239, including, for example, the embodiments having amplification members, steel or composite members, or viscous or viscoelastic-based damping members.

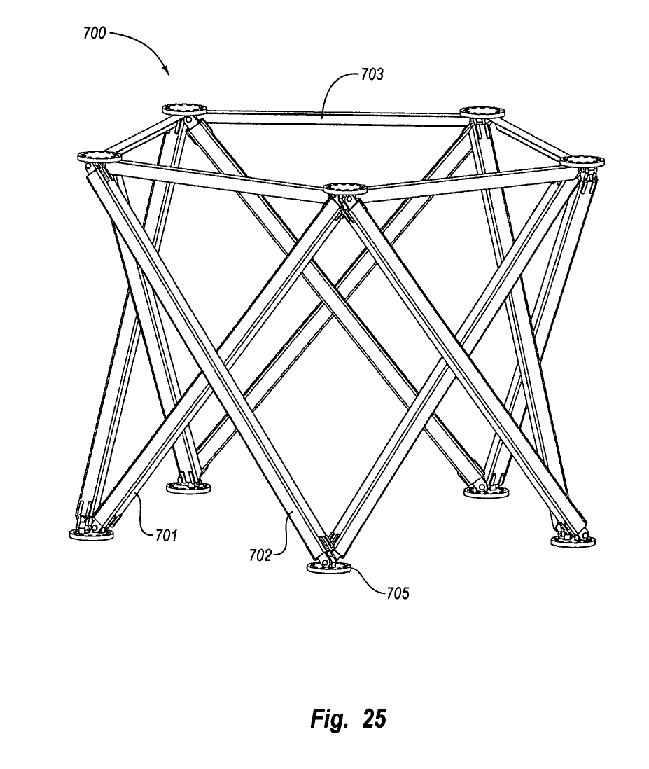

Referring now to FIG. 25, an alternative bay section 700 of the present invention is disclosed. The bay section 700 includes pairs of first 701 and second 702 diagonal members positioned at each face of the bay section 700. Horizontal members 703 are arranged about the perimeter of the bay section 700, but may be eliminated if the bay section 700 were incorporated into a conventional tube tower such as that illustrated in FIG. 24. The use of pairs of diagonals on one or more faces of the bay section enables corresponding longitudinal members to be eliminated. As illustrated, each end of the first 701 and second 702 diagonal members is connected to a flange 705. As further illustrated, the connections are offset from one another to permit the crisscrossing of the pairs of diagonal members 701, 702. The bay section 700 may be repeated along the length of the structural tower, as illustrated generally in FIG. 1, or may be substituted for any one or more bay sections that include generally both longitudinal and diagonal members. Further, the bay section 700 can include any combination of damped or un-damped diagonal members or dashpot and spring element combinations, exemplary details of which are as described above. In similar fashion, individual bay sections may comprise only longitudinal members, and be substituted for any one or more bay sections that include generally both longitudinal and diagonal members, and can include any combination of damped or un-damped longitudinal members or dashpot and spring element combinations, exemplary details of which are as described above.

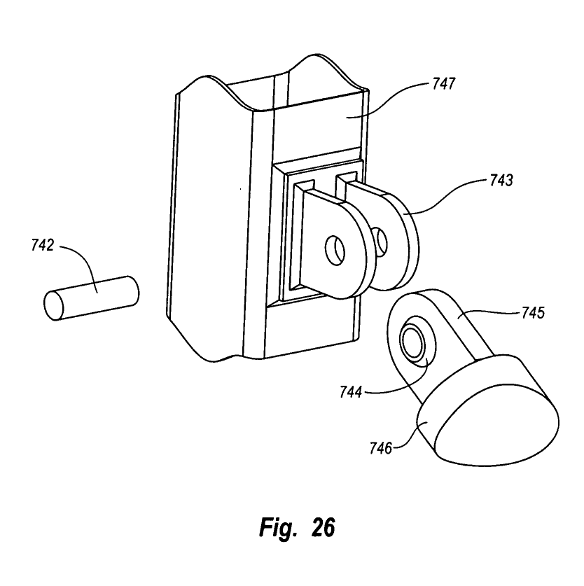

Referring now to FIG. 26, an alternative embodiment for constructing a pin joint of the present invention is illustrated. The alternative pin and ball joint 741 includes a pin 742, a pair of flange members or tabs 743 and a spherical ball 744 in sliding contact with the end tab 745 of a damped or undamped diagonal member (or, alternatively, a dashpot or spring element) 746. The pin 742 (or, alternatively the expanding pin from above) is inserted through the tabs 743 and ball 744 in similar fashion as that described above, and creates a section joint that allows zero or minimal axial movement of the diagonal member with respect to the corresponding longitudinal member 747. Alternatively, the tabs 743 on the longitudinal member 743 can be positioned on the diagonal member 746, with the tab 745 and spherical ball 744 positioned on the longitudinal member 747, with no change in function of the joint. The assembled pin and ball joint 741 does, however, permit side-to-side movement and rotational movement about the pin 742, which may facilitate construction of one or more bay assemblies comprising the space frame tower of the present invention. Ball joint assemblies 741 of the type described here are commercially available in a variety of sizes through, for example, Taylor Devices, Inc., North Tonawanda, N.Y. As with the foregoing discussion, the pin and ball joint 741 assemblies can be used to connect longitudinal, diagonal or horizontal members to one another, or any such member to a flange for subsequent connection.

While the foregoing description has focused principally on the use of the structural tower for land based installations, the structural tower of the present invention has similar applications for offshore use. In one embodiment, the longitudinal and diagonal members of the structural tower extending below the water surface are increased in wall thickness to about three-quarter to about one inch where the members are constructed from steel having square cross section, although members having cross sections that are round, I-beam or C-channel may, for example, also be used. Above the water surface, this embodiment uses one or more of the same damped and non-damped longitudinal and diagonal members described above. Increasing the wall thickness of the steel members below the surface results in increased ability to withstand currents and wave impact. The remaining portions of the structural tower above the water surface are constructed as described above to withstand the resonant vibrations of the tower. If desired, damping members may be incorporated into portions of the structural tower below the surface of the water as well to affect damping of vibrations caused by ocean currents and wave action. In this fashion, towers are constructed in water depths of between fifteen and one hundred meters, with the above water portion of the tower extending to elevations approaching sixty-five to one hundred meters. For structural towers of the present invention constructed either on or off shore, a modular shell covering, made of any suitable material, may be secured to the longitudinal or diagonal members to cover the internal structure of the structural tower. The shell covering gives the structural tower 10 the appearance of the more conventional tube towers of the present invention.

While certain embodiments and details have been included herein and in the attached invention disclosure for purposes of illustrating the invention, it will be apparent to those skilled in the art that various changes in the methods and apparatuses disclosed herein may be made without departing form the scope of the invention, which is defined in the appended claims.

What is claimed is:

1. A structural tower for wind turbine applications, comprising:
a plurality of upwardly directed longitudinal members;
a plurality of diagonal members interconnecting the longitudinal members; and
wherein at least one of the longitudinal and diagonal members is a damping member.

2. The structural tower of claim 1, wherein the at least one damping member includes a dashpot.

3. The structural tower of claim 1, wherein the at least one damping member includes:
a first member having first and second ends configured to interconnect a pair of the longitudinal members;
a second member disposed within the first member and having a first end connected to the first member and a second end, the second member having an effective stiffness different from the first member; and
a viscous damper containing a viscous fluid operably connected to both the first and second members.

4. The structural tower of claim 3, wherein the viscous damper includes:
a cylinder;
a piston slidably engaged within the cylinder; and
a connecting member having a first end connected to the piston and a second end connected to the second end of the second member.

5. The structural tower of claim 4, wherein the viscous damper further includes an accumulator in fluid communication with the viscous fluid.

6. The structural tower of claim 1, wherein the at least one damping member is disposed diagonally between and interconnects a pair of longitudinal members.

7. The structural tower of claim 1, wherein the at least one damping member is disposed longitudinally between and interconnects a pair of longitudinal members.

8. The structural tower of claim 1, wherein the at least one damping member is disposed substantially horizontally between an interconnects a pair of longitudinal members.

9. The structural tower of claim 1, wherein the plurality of longitudinal members and the plurality of diagonal members are arranged and interconnected in an upwardly extending multiple-bay configuration.

10. The structural tower of claim 9, wherein each bay of the multiple-bay configuration comprises at least three upwardly directed longitudinal members.

11. The structural tower of claim 9, wherein each bay of the multiple-bay configuration comprises:
at least three upwardly directed longitudinal members spaced substantially equidistant about a longitudinal axis.

12. The structural tower of claim 1, wherein the at least one damping member comprises an outer tubular member and an inner tubular member disposed within the outer tubular member, the inner and outer tubular members having first and second ends and being fixedly connected to each other at the first ends, the first and second ends of the outer tubular member being interconnecting a pair of longitudinal member, and the second end of the inner tubular member being operatively connected to a viscous damper having a viscous fluid.

13. A structural tower for wind turbine applications, comprising:
a plurality of upwardly directed longitudinal members;
a plurality of diagonal members interconnecting the longitudinal members;
wherein the plurality of longitudinal members and the plurality of diagonal members are arranged and interconnected in an upwardly extending multiple-bay configuration; and
a pin connecting a longitudinal member to one of an adjacent longitudinal member or an adjacent diagonal member.

14. The structural tower of claim 13, wherein a first bay of the multiple-bay configuration includes at least three upwardly directed longitudinal members spaced substantially equidistant about a longitudinal axis.

15. The structural tower of claim 14, further including a diagonal member interconnecting an adjacent pair of the at least three upwardly directed longitudinal members.

16. The structural tower of claim 15, further including a pin interconnecting one end of the diagonal member to a corresponding one of the adjacent pair of longitudinal members.

17. The structural tower of claim 16, wherein the one end of the diagonal member includes a flange member having an aperture sized and configured to tightly receive the pin.

18. The structural tower of claim 16, wherein the corresponding one of the adjacent pair of longitudinal members includes a flange member having an aperture sized and configured to tightly receive the pin.

19. A method of assembling a structural tower for wind turbine applications, comprising the steps:
providing a first plurality of longitudinal members, each longitudinal member having a first end and a second end;
providing a first plurality of diagonal members;
providing a foundation for the structural tower, the foundation having a plurality of support members, each support member configured to receive an end of one of the first plurality of longitudinal members;
connecting an end of a first one of the first plurality of longitudinal members to a corresponding first one of the plurality of support members;
connecting an end of a second one of the first plurality of longitudinal members to a corresponding second one of the plurality of support members;
interconnecting the first and second ones of the first plurality of longitudinal members with a first one of the first plurality of diagonal members;
connecting an end of the remaining ones of the first plurality of longitudinal members to corresponding support members of the remaining ones of the plurality of support members; and
interconnecting the remaining ones of the first plurality of longitudinal members with corresponding diagonal members of the remaining ones of the first plurality of diagonal members;
wherein the plurality of longitudinal members and the plurality of diagonal members are arranged and interconnected in an upwardly extending bay configuration.

20. The method of claim 19, comprising the further steps:
providing a second plurality of longitudinal members, each longitudinal member having a first end and a second end;
providing a second plurality of diagonal members;
connecting an end of a first one of the second plurality of longitudinal members to a corresponding end of a first one of the first plurality of longitudinal members;
connecting an end of a second one of the second plurality of longitudinal members to a corresponding end of a second one of the first plurality of longitudinal members;
interconnecting the first and second ones of the second plurality of longitudinal members with a first one of the second plurality of diagonal members;
connecting an end of the remaining ones of the second plurality of longitudinal members to corresponding ends of the remaining ones of the first plurality of longitudinal members; and
interconnecting the remaining ones of the second plurality of longitudinal members with corresponding diagonal members of the remaining ones of the second plurality of diagonal members;
wherein the pluralities of first and second longitudinal members and the pluralities of first and second diagonal members are arranged and interconnected in an upwardly extending multiple-bay configuration.
